(19) United States
(12) Patent Application Publication
(10) Pub. No.: US 2016/0135021 A1
(43) Pub. Date: May 12, 2016

(54) Conversation Merging Method and Mobile Terminal

(71) Applicant: Huawei Technologies Co., Ltd., Shenzhen (CN)

(72) Inventor: Jianhua He, Shenzhen (CN)

(21) Appl. No.: 14/983,202

(22) Filed: Dec. 29, 2015

Related U.S. Application Data
(63) Continuation of application No. PCT/CN2015/072401, filed on Feb. 6, 2015.

(30) Foreign Application Priority Data
Aug. 25, 2014 (CN) 201410422495.7

(51) Int. Cl. H04W 4/14; G06F 3/0482; H04L 12/58

(52) U.S. Cl. CPC H04W 4/14; H04L 51/36; H04L 51/22; G06F 3/0482

(57) ABSTRACT

A conversation merging method including acquiring M first conversations, where M numbers in one-to-one correspondence with the M first conversations meet a preset merging rule, and each first conversation in the M first conversations includes at least one message; and merging the M first conversations into a second conversation, and displaying the second conversation, where display content of the second conversation includes messages included in the M first conversations. Multiple first conversations whose numbers meet a merging rule are merged into one second conversation, and only the second conversation is displayed, which simplifies display of a conversation interface and facilitates reading and operating of a user, so that user experience is improved.

### CROSS-REFERENCE TO RELATED APPLICATIONS

This application is a continuation of International Application No. PCT/CN2015/072401, filed on Feb. 6, 2015, which claims priority to Chinese Patent Application No. 201410422495.7, filed on Aug. 25, 2014, both of which are hereby incorporated by reference in their entireties.

### TECHNICAL FIELD

Embodiments of the present disclosure relate to the communications field, and more specifically, to a conversation merging method and a mobile terminal.

### BACKGROUND

With the popularity of smartphones, display of a short message service (SMS) message on a mobile phone has developed from a conventional folder manner to a conversation manner. In the conventional folder manner, there are an inbox, an outbox, a draft box, and the like. In the conversation manner, all information of a same number is displayed in a same conversation. Generally, all information in a same conversation is displayed by time in order or in a reverse order.

In a same conversation, there are both received information and sent information. However, a number of a sender of the received information is the same as a number of a recipient of the sent information, and therefore, the two numbers are also referred to as a number of the same conversation.

If this number is already stored in an address book, a conversation name may be a name that is stored in the address book and corresponding to the number. If this number has not been stored in the address book, the conversation name may be the number.

However, a terminal may receive multiple pieces of information from one sender that has different numbers. The different numbers may be the same in length, or may be different in length.

For example, a terminal receives SMS messages from both 95588 and 106575595588; then the terminal respectively displays the SMS messages from 95588 and 106575595588 by using two conversations. However, in reality, both 95588 and 106575595588 are numbers belonging to bank A. In this case, for a user, different numbers that belong to a same sender are displayed in multiple conversations, which causes dispersed information and complex display of a conversation interface.

### SUMMARY

Embodiments of the present disclosure provide a conversation merging method, which can simplify display of a conversation interface, so that user experience is improved.

According to a first aspect, a conversation merging method is provided, where the method is applied to a mobile terminal, and the method includes acquiring M first conversations, where M numbers in one-to-one correspondence with the M first conversations meet a preset merging rule, each first conversation in the M first conversations includes at least one message, the message is a received message or a sent message, a number corresponding to each first conversation in the M first conversations is a number of the message at least included in each first conversation in the M first conversations, the number of the message is a number of a sender of the received message or a number of a recipient of the sent message, and M is a positive integer greater than or equal to 2; and merging the M first conversations into a second conversation, and displaying the second conversation, where display content of the second conversation includes messages included in the M first conversations.

With reference to the first aspect, in a first possible implementation manner of the first aspect, the preset merging rule includes a merging mode and a merging condition corresponding to the merging mode; and the merging mode is a same-prefix mode, the merging condition corresponding to the merging mode is a first number, and that M numbers meet a preset merging rule includes that prefix numbers of the M numbers are all the first number; or the merging mode is a same-suffix mode, the merging condition corresponding to the merging mode is a second number, and that M numbers meet a preset merging rule includes that suffix numbers of the M numbers are all the second number.

With reference to the first aspect, in a second possible implementation manner of the first aspect, the preset merging rule is a preset number set; and that M numbers meet a preset merging rule includes that the M numbers all belong to the preset number set.

With reference to the first aspect or either of the foregoing possible implementation manners of the first aspect, in a third possible implementation manner of the first aspect, the method further includes receiving reply information and a reply instruction that are made by a user in response to the second conversation; extracting a number list of the second conversation according to the reply instruction, where the number list includes the M numbers; displaying the number list, so that the user selects a reply number from the M numbers; and sending the reply information to the reply number.

With reference to the first aspect or any one of the foregoing possible implementation manners of the first aspect, in a fourth possible implementation manner of the first aspect, the preset merging rule is set by the user, and before the acquiring M first conversations, the method further includes receiving the preset merging rule set by the user.

With reference to the fourth possible implementation manner of the first aspect, in a fifth possible implementation manner of the first aspect, the receiving the preset merging rule set by the user includes receiving the user's instruction on selecting at least two first conversations from the M first conversations; acquiring at least two numbers in one-to-one correspondence with the at least two first conversations; and generating the preset merging rule according to a common characteristic of the at least two numbers, where the common characteristic includes some same digits in the at least two numbers.

With reference to the fifth possible implementation manner of the first aspect, in a sixth possible implementation manner of the first aspect, the method further includes receiving the user's modify operation performed on the preset merging rule, and determining a new merging rule as the preset merging rule according to the modify operation.

With reference to any possible implementation manner of the fourth possible implementation manner of the first aspect to the sixth possible implementation manner of the first aspect, in a seventh possible implementation manner of the first aspect, the method further includes receiving an exclusive number that is entered by the user and corresponding to the preset merging rule; and that M numbers meet a preset merging rule includes that the M numbers meet the preset merging rule, and the M numbers do not belong to the exclusive number corresponding to the preset merging rule.

With reference to the first aspect or any one of the foregoing possible implementation manners of the first aspect, in an eighth possible implementation manner of the first aspect, the display content of the second conversation further includes a conversation name, and the conversation name is a default name or a user-defined name.

With reference to the first aspect or any one of the foregoing possible implementation manners of the first aspect, in a ninth possible implementation manner of the first aspect, the first conversation is an SMS message conversation, the second conversation is an SMS message conversation, and the messages are SMS messages.

According to a second aspect, a mobile terminal is provided, where the mobile terminal includes an acquiring unit configured to acquire M first conversations, where M numbers in one-to-one correspondence with the M first conversations meet a preset merging rule, each first conversation in the M first conversations includes at least one message, the message is a received message or a sent message, a number corresponding to each first conversation in the M first conversations is a number of the message at least included in each first conversation in the M first conversations, the number of the message is a number of a sender of the received message or a number of a recipient of the sent message, and M is a positive integer greater than or equal to 2; a merging unit configured to merge the M first conversations acquired by the acquiring unit into a second conversation; and a display unit configured to display the second conversation obtained after the merging by the merging unit, where display content of the second conversation includes messages included in the M first conversations.

With reference to the second aspect, in a first possible implementation manner of the second aspect, the preset merging rule includes a merging mode and a merging condition corresponding to the merging mode; and the merging mode is a same-prefix mode, the merging condition corresponding to the merging mode is a first number, and that M numbers meet a preset merging rule includes that prefix numbers of the M numbers are all the first number; or the merging mode is a same-suffix mode, the merging condition corresponding to the merging mode is a second number, and that M numbers meet a preset merging rule includes that suffix numbers of the M numbers are all the second number.

With reference to the second aspect, in a second possible implementation manner of the second aspect, the preset merging rule is a preset number set; and that M numbers meet a preset merging rule includes that the M numbers all belong to the preset number set.

With reference to the second aspect or either of the foregoing possible implementation manners of the second aspect, in a third possible implementation manner of the second aspect, the mobile terminal further includes a receiving unit configured to receive reply information and a reply instruction that are made by a user in response to the second conversation displayed by the display unit; an extracting unit configured to extract, according to the reply instruction received by the receiving unit, a number list of the second conversation displayed by the display unit, where the number list includes the M numbers; where the display unit is further configured to display the number list, so that the user selects a reply number from the M numbers; and a sending unit configured to send the reply information received by the receiving unit to the reply number.

With reference to the second aspect or any one of the foregoing possible implementation manners of the second aspect, in a fourth possible implementation manner of the second aspect, the preset merging rule is set by the user, and the mobile terminal further includes the receiving unit configured to receive the preset merging rule set by the user.

With reference to the fourth possible implementation manner of the second aspect, in a fifth possible implementation manner of the second aspect, the receiving unit is further configured to receive the user's instruction on selecting at least two first conversations from the M first conversations; acquire at least two numbers in one-to-one correspondence with the at least two first conversations; and generate the preset merging rule according to a common characteristic of the at least two numbers, where the common characteristic includes some same digits in the at least two numbers.

With reference to the fifth possible implementation manner of the second aspect, in a sixth possible implementation manner of the second aspect, the receiving unit is further configured to receive the user's modify operation performed on the preset merging rule, and determine a new merging rule as the preset merging rule according to the modify operation.

With reference to any possible implementation manner of the fourth possible implementation manner of the second aspect to the sixth possible implementation manner of the second aspect, in a seventh possible implementation manner of the second aspect, the receiving unit is further configured to receive an exclusive number that is entered by the user and corresponding to the preset merging rule; and that M numbers meet a preset merging rule includes that the M numbers meet the preset merging rule, and the M numbers do not belong to the exclusive number corresponding to the preset merging rule.

With reference to the second aspect or any one of the foregoing possible implementation manners of the second aspect, in an eighth possible implementation manner of the second aspect, the display content of the second conversation further includes a conversation name, and the conversation name is a default name or a user-defined name.

With reference to the second aspect or any one of the foregoing possible implementation manners of the second aspect, in a ninth possible implementation manner of the second aspect, the first conversation is an SMS message conversation, the second conversation is an SMS message conversation, and the messages are SMS messages.

In this way, in the embodiments of the present disclosure, multiple conversations whose numbers meet a merging rule are merged into one conversation, and display of the multiple conversations before the merging is canceled, which can simplify display of a conversation interface and facilitate reading and operating of a user, so that user experience can be improved.

### BRIEF DESCRIPTION OF DRAWINGS

To describe the technical solutions in the embodiments of the present disclosure more clearly, the following briefly introduces the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a schematic diagram of a logical structure of a mobile terminal;

FIG. 2 is a flowchart of a conversation merging method according to an embodiment of the present disclosure;

FIG. 3 is a flowchart of a method for setting a merging rule according to an embodiment of the present disclosure;

FIG. 4 is a schematic diagram of a merging setting main interface according to an embodiment of the present disclosure;

FIG. 5 is a schematic diagram of a merging setting interface according to an embodiment of the present disclosure;

FIG. 6 is a schematic diagram of a merging setting interface according to another embodiment of the present disclosure;

FIG. 7 is a flowchart of a method for acquiring M first conversations according to an embodiment of the present disclosure;

FIG. 8 is a schematic diagram of a relationship between tables for storing an SMS message in an Android system;

FIG. 9 is a flowchart of a method for performing matching between a number and a merging rule in an Android system according to an embodiment of the present disclosure;

FIG. 10 is a flowchart of a method for displaying a second conversation according to an embodiment of the present disclosure;

FIG. 11 is a schematic diagram of an interface of a second conversation according to an embodiment of the present disclosure;

FIG. 12 is a flowchart of a method for replying to a second conversation according to an embodiment of the present disclosure;

FIG. 13 is an example of a schematic diagram of a reply number list according to an embodiment of the present disclosure;

FIG. 14 is another example of a schematic diagram of a reply number list according to an embodiment of the present disclosure;

FIG. 15 is a flowchart of a method for setting a merging rule according to another embodiment of the present disclosure;

FIG. 16 is a schematic diagram of a conversation merging interface according to an embodiment of the present disclosure;

FIG. 17 is a schematic diagram of an interface for newly adding a merging rule according to another embodiment of the present disclosure;

FIG. 18 is a flowchart of a method for presenting an interface for newly adding a merging rule according to an embodiment of the present disclosure;

FIG. 19 is a schematic diagram of input information of a user in an interface for newly adding a merging rule according to an embodiment of the present disclosure;

FIG. 20 is a schematic diagram of a conversation presentation interface after conversation merging according to an embodiment of the present disclosure;

FIG. 21 is a block diagram of a mobile terminal according to an embodiment of the present disclosure;

FIG. 22 is a block diagram of a mobile terminal according to another embodiment of the present disclosure; and

FIG. 23 is a schematic structural diagram of a mobile terminal according to another embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

The terms “component”, “module”, “system”, and the like used in this specification are used to indicate an entity, hardware, firmware, a combination of hardware and software, software, or software in execution related to a computer. For example, a component may be but is not limited to a process running on a processor, a processor, an object, an executable file, an execution thread, a program, and/or a computer. By means of graphical representation, both an application running on a computing device and the computing device may be components. One or more components may reside in a process and/or an execution thread, and components may be located on one computer and/or distributed on two or more computers. In addition, these components may be executed on various computer readable media on which various data structures are stored. Components may communicate, for example, according to a signal that has one or more data packets (for example, data of two components that interact with another component from a local system, a distributed system, and/or a network, and for example, the Internet that interacts with another system by using a signal), with each other by using a local and/or remote process.

In addition, aspects or features of the present disclosure may be implemented as a method, an apparatus or a product that uses standard programming and/or engineering technologies. The term “product” used in this application covers a computer program that can be accessed from any computer readable component, carrier, or medium. For example, the computer readable medium may include but is not limited to a magnetic storage component (for example, a hard disk, a floppy disk, or a magnetic tape), an optical disc (for example, a compact disk (CD) or a digital versatile disk (DVD)), a smart card and a flash memory component (for example, an erasable programmable read-only memory (EPROM), a card, a stick, or a key drive). In addition, various storage media described in this specification may represent one or more devices and/or another machine readable medium used to store information. The term “machine readable medium” may include but is not limited to a radio channel, and various other media that can store, include, and/or carry an instruction and/or data.

In addition, the embodiments are described in combination with a mobile terminal. The mobile terminal may also be referred to as a terminal, a system, a subscriber unit, a subscriber station, a mobile station, a mobile platform, a remote station, a remote terminal, a mobile device, a user terminal, a terminal device, an access terminal, a wireless communications device, a user agent, or a user apparatus or a user equipment (UE). The mobile terminal may be a cellular phone, a cordless telephone set, a session initiation protocol (SIP) phone, a wireless local loop (WLL) station, a personal digital assistant (PDA), a handheld device that has a wireless communication function, a computing device, or another processing device that is connected to a wireless modem.

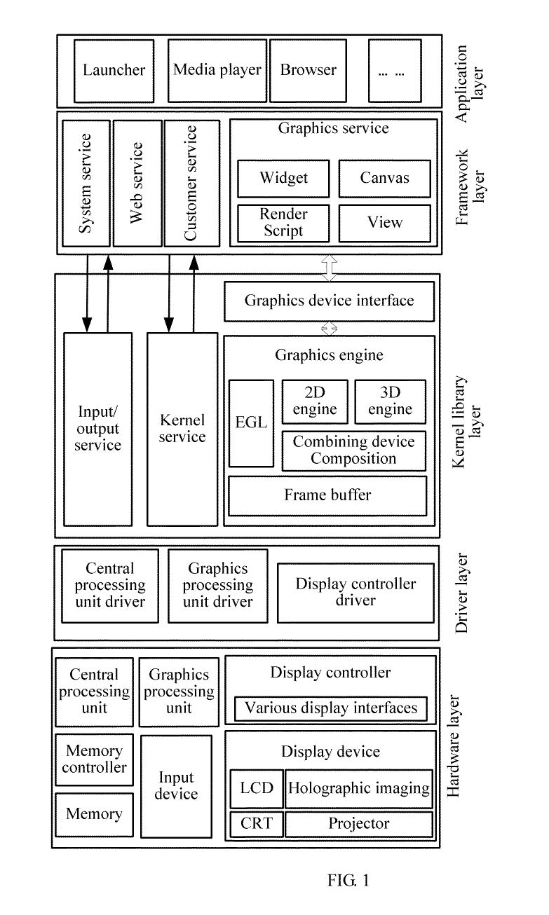

FIG. 1 is an exemplary diagram of a logical structure of a mobile terminal. The mobile terminal includes an application layer, a framework layer, a kernel library layer, a driver layer, and a hardware layer. The application layer may include a launcher, a media player, a browser, and the like. The framework layer may include a graphics service, a system service, a web service, a customer service, and the like. In the graphics service, a widget, a canvas, a view, render script, and the like may be included. A kernel library layer is a kernel part of an operating system and includes an input/output (I/O) service, a kernel service, a graphics device interface (GDI), a graphics engine that implements graphics processing of a central processing unit (CPU) and a graphics processing unit (GPU), and the like. The graphics engine may include a 2-dimensional (2D) engine, a 3-dimensionnal (3D) engine, a combining unit, a frame buffer, an Embedded-system Graphics Library (EGL), and the like. The driver layer may include a CPU driver, a GPU driver, a display controller driver, and the like. The hardware layer includes a CPU, a GPU, and the like, and certainly, may further include a memory, an I/O input/output, a double data rate (DDR), a DDR controller (DDRC), a network interface, and the like. An input device may include a keyboard, a mouse, a touchscreen, and the like. An output device may include a display device such as a liquid crystal display (LCD), a cathode ray tube (CRT), a holographic imaging device, or a projector. An operating system (such as Android® or iOS®) and some application programs may run at the hardware layer.

It may be understood that a conversation merging method is provided in an embodiment of the present disclosure, and an execution body of the method is a mobile terminal. For example, the mobile terminal may be a mobile telephone (or referred to as a mobile phone, a smartphone, or the like). For a logical structure of the mobile terminal, reference may be made to FIG. 1.

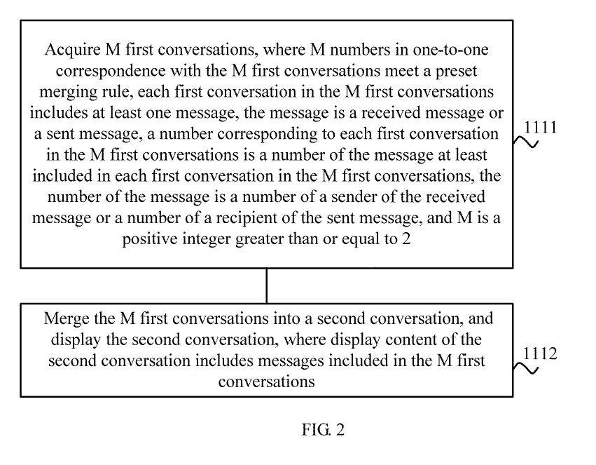

FIG. 2 is a flowchart of a conversation merging method according to an embodiment of the present disclosure. Referring to FIG. 1, the method may be implemented at an application layer. The method may be a method for improving an existing module, such as a message module or a conversation module, at the application layer. The method shown in FIG. 2 includes:

Step 1111: Acquire M first conversations, where M numbers in one-to-one correspondence with the M first conversations meet a preset merging rule, each first conversation in the M first conversations includes at least one message, the message is a received message or a sent message, a number corresponding to each first conversation in the M first conversations is a number of the message at least included in each first conversation in the M first conversations, the number of the message is a number of a sender of the received message or a number of a recipient of the sent message, and M is a positive integer greater than or equal to 2.

Step 1112: Merge the M first conversations into a second conversation, and display the second conversation, where display content of the second conversation includes messages included in the M first conversations.

In this way, in this embodiment of the present disclosure, multiple first conversations whose numbers meet a merging rule are merged into one second conversation, and display of the multiple conversations before the merging is canceled, which can simplify display of a conversation interface and facilitate reading and operating of a user, so that user experience can be improved.

In this embodiment of the present disclosure, a conversation is a communication mode, and may be performed between terminals or may be performed between a terminal and a server, which is not limited in the present disclosure. In addition, communication content is a message. For example, a conversation may be an instant message (IM) conversation. For another example, a conversation may be an SMS message conversation on a mobile telephone.

Optionally, in an embodiment, both the first conversation and the second conversation are IM conversations, and the messages are IM messages.

Correspondingly, step 1111 is acquiring M first IM conversations, where M numbers in one-to-one correspondence with the M first IM conversations meet a preset merging rule, each first IM conversation in the M first IM conversations includes at least one IM message, the IM message is a received IM message or a sent IM message, a number corresponding to each first IM conversation in the M first IM conversations is a number of the IM message at least included in each first IM conversation in the M first IM conversations, the number of the IM message is a number of a sender of the received IM message or a number of a recipient of the sent IM message, and M is a positive integer greater than or equal to 2. Step 1112 is merging the M first IM conversations into a second IM conversation, and displaying the second IM conversation, where display content of the second IM conversation includes IM messages included in the M first IM conversations.

For example, IM may be Weibo (Weibo or MicroBlog), WeChat, EasyChat, MiTalk, Facebook®, Twitter®, LinkedIn®, and the like.

A number corresponding to an IM conversation may be an identity (ID) of a user who participates in the IM conversation. For example, the number may be a user name when the user registers IM, or may be the name of a user. It may be understood that the number may be in a form of a character such as a letter, a digit, or a symbol.

Optionally, in another embodiment, both the first conversation and the second conversation are SMS message conversations, and the messages are SMS messages.

Correspondingly, step 1111 is acquiring M first SMS message conversations, where M numbers in one-to-one correspondence with the M first SMS message conversations meet a preset merging rule, each first SMS message conversation in the M first SMS message conversations includes at least one SMS message, a number corresponding to each first SMS message conversation in the M first SMS message conversations is a number of the SMS message at least included in each first SMS message conversation in the M first SMS message conversations, and M is a positive integer greater than or equal to 2. Step 1112 is merging the M first SMS message conversations into a second SMS message conversation, and displaying the second SMS message conversation, where display content of the second SMS message conversation includes SMS messages included in the M first SMS message conversations.

A number corresponding to a conversation may be a number of an SMS message, that is, a number of a mobile terminal of a user who participates in the SMS message conversation. For example, the number may be a mobile number. Generally, the mobile number is in a form of a digit. It may be understood that by means of expansion, the mobile number may also be in a form of another character such as a letter or a symbol.

It should be noted that an SMS message may be a received SMS message or a sent SMS message. Then, it may be understood that a number of the SMS message is a number of a sender of the received SMS message or a number of a recipient of the sent SMS message.

For ease of description, an SMS message conversation is used as an example for description in the following embodiments of the present disclosure.

Optionally, in an embodiment, the preset merging rule may be a preset number set. Then, in step 1111, that M numbers meet a preset merging rule includes that the M numbers all belong to the preset number set.

Optionally, in another embodiment, the preset merging rule may include a merging mode and a merging condition corresponding to the merging mode.

The merging mode is a same-prefix mode, the merging condition corresponding to the merging mode is a first number, and then, in step 1111, that M numbers meet a preset merging rule includes that prefix numbers of the M numbers are all the first number; or the merging mode is a same-suffix mode, the merging condition corresponding to the merging mode is a second number, and then, in step 1111, that M numbers meet a preset merging rule includes that suffix numbers of the M numbers are all the second number.

It should be noted that in this embodiment of the present disclosure, the “prefix” and the “suffix” may be understood as a front part of a number and a rear part of a number of a number. For example, if a number is 1234567, a prefix of the number may be 123 or 12, and a suffix may be 67 or 7. For another example, if a number is 123-4567, a prefix of the number may be 123, and a suffix may be 67 or 7. There are multiple specific situations in an actual application, and no enumeration is performed in this embodiment of the present disclosure again. In addition, this embodiment of the present disclosure imposes no limitation on specific digits of a “prefix” and a “suffix” of a number.

Optionally, in another embodiment, the preset merging rule may include a merging mode and a merging condition corresponding to the merging mode. The merging mode is an exact match mode, and the merging condition corresponding to the merging mode is a number set. Then, in step 1111, that M numbers meet a preset merging rule includes that the M numbers all belong to the number set.

Optionally, in another embodiment, the preset merging rule may be a preset regular expression. Then, in step 1111, that M numbers meet a preset merging rule includes that the M numbers all match the preset regular expression.

In this embodiment of the present disclosure, a regular expression is a concept of computer science that has been widely applied, and the regular expression is described by using a single character string, and is used to match a series of character strings that meet a syntactic rule. The regular expression is a logical formula for operating a character string, that is, some predefined specific characters and a combination of these specific characters are used to form one “regular character string”, and this “regular character string” is used to express a type of filtering logic for a character string.

Optionally, in another embodiment, the preset merging rule may include a merging mode and a merging condition corresponding to the merging mode. The merging mode is an advanced mode, and the merging condition corresponding to the merging mode is a regular expression. Then, in step 1111, that M numbers meet a preset merging rule includes that the M numbers all match the regular expression.

Optionally, in this embodiment of the present disclosure, the preset merging rule may be preset by a manufacturer of a mobile terminal. For example, the preset merging rule may be a regular expression “.*95588$” that is used to merge conversations corresponding to numbers with a suffix being 95588.

Optionally, in this embodiment of the present disclosure, the preset merging rule may be set by a user. Then, correspondingly, before step 1111, the method should further include receiving the preset merging rule set by the user.

It may be understood that the merging rule is user-defined. Then, the user may also perform a modify operation or delete operation on an existing merging rule. That is, before step 1111, the method may further include receiving the user's modify operation performed on the preset merging rule, and determining a new merging rule as the preset merging rule according to the modify operation.

Optionally, in an embodiment, before step 1111, the method may further include receiving an exclusive number that is entered by the user and corresponding to the preset merging rule. Then, correspondingly, in step 1111, that M numbers meet a preset merging rule includes that the M numbers meet the preset merging rule, and the M numbers do not belong to the exclusive number corresponding to the preset merging rule.

In this way, in this embodiment of the present disclosure, an exclusive number may be set, so as to prevent error merging.

Optionally, before step 1111, the receiving the preset merging rule set by the user may include receiving the user's instruction on selecting at least two first conversations from the M first conversations; acquiring at least two numbers in one-to-one correspondence with the at least two first conversations; and generating the preset merging rule according to a common characteristic of the at least two numbers, where the common characteristic includes some same digits in the at least two numbers.

This setting manner may be considered as a semi-automatic manner, and the user can complete conversation merging only by selecting at least two of conversations that the user wants to merge. In this way, an operation of setting a merging rule by the user can be simplified, and user experience can be improved.

Generally, in a conversation display interface, a displayed first conversation includes a corresponding conversation name. For example, a conversation name of an SMS message conversation may be a number of an SMS message or a name that is stored in an address book and corresponding to a number of an SMS message.

Optionally, a conversation name of the second conversation that is obtained after merging and displayed in step 1112 may be blank. Alternatively, optionally, the second conversation that is obtained after merging and displayed in step 1112 may further include a conversation name, where the conversation name may be a default name or a user-defined name.

Then, it may be understood that before step 1111, when setting the preset merging rule, the user may also set a display name corresponding to the preset merging rule. In this case, in step 1112, the display name may be used as the conversation name of the second conversation. The default name may be a conversation name that is automatically determined by a terminal according to a historical setting of the user, or a conversation name extracted by a terminal according to content of the conversation (which may be a part of the content of the conversation), or a name predetermined by a terminal, for example, “merging conversation (n)” used to indicate the n^{th} merging conversation (n is an integer greater than or equal to 1). There are multiple specific implementation manners, and details are not described herein again in this embodiment of the present disclosure.

Setting the preset merging rule by the user is described in detail in the following.

Optionally, it is assumed that when performing setting, the user sets both a merging rule and a display name corresponding to the merging rule.

It may be understood that the user may create a merging rule and a display name corresponding to the merging rule, or the user may edit or delete an existing merging rule and a display name corresponding to the merging rule.

Optionally, the merging rule may include a merging mode and a merging condition corresponding to the merging mode. The merging mode and the merging condition may be shown in the foregoing. That is, the merging mode may be one of the same-prefix mode, the same-suffix mode, the exact match mode, and the advanced mode.

In this way, several optional merging modes are provided, facilitating setting of a merging rule by a user, and simplifying use for the user.

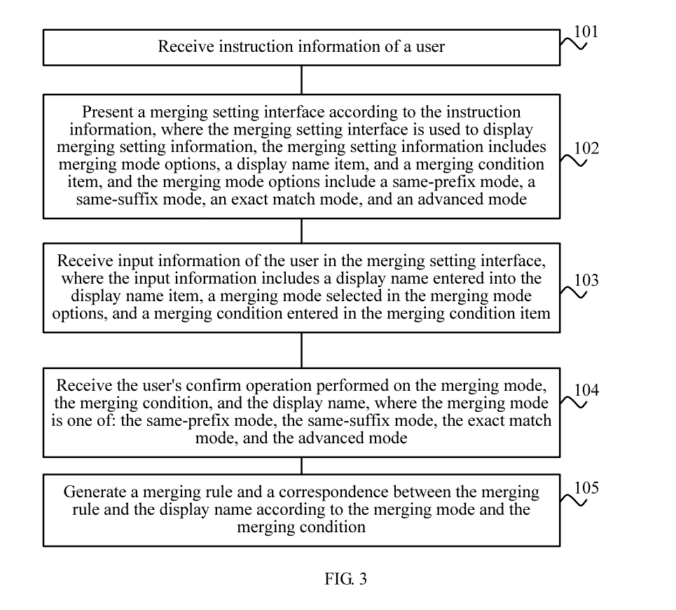

Optionally, in an embodiment, as shown in FIG. 3, before step 1111, the receiving the preset merging rule set by the user may include:

101. Receive instruction information of the user.

102. Present a merging setting interface according to the instruction information, where the merging setting interface is used to display merging setting information, the merging setting information includes merging mode options, a display name item, and a merging mode options, and the merging mode options include a same-prefix mode, a same-suffix mode, an exact match mode, and an advanced mode.

103. Receive input information of the user in the merging setting interface, where the input information includes a display name entered in the display name item, a merging mode selected in the merging mode options, and a merging mode options merging condition entered in the merging mode options.

104. Receive the user's confirm operation performed on the merging mode, the merging condition, and the display name, where the merging mode is one of the same-prefix mode, the same-suffix mode, the exact match mode, and the advanced mode.

105. Generate a merging rule and a correspondence between the merging rule and the display name according to the merging mode and the merging condition.

In this way, in this embodiment of the present disclosure, a merging setting interface is provided, which can facilitate an operation of a user and exhibit relatively high operability.

Optionally, before step 101, the method may further include: receiving information about tapping a merging setting button by the user, and presenting a merging setting main interface, where the merging setting main interface is used to display a merging rule table, and the merging rule table is used to display a correspondence between a merging rule and a display name.

An SMS message setting menu of the mobile terminal may include a merging setting submenu, and the receiving information about tapping a merging setting button by the user may be acquiring information about a gesture made by the user at a specific location in an interface of the SMS message setting menu. Herein, the specific location refers to a location of the merging setting submenu. That is, the user taps the merging setting button may refer to that the user taps the merging setting submenu. It should be noted that in this embodiment of the present disclosure, the SMS message setting menu may be a setting menu in a display interface of an SMS message conversation, or may be an SMS message setting menu in a system setting menu, which is not limited in the present disclosure.

Further, after the information about tapping the merging setting button by the user is received, the merging setting main interface may be presented, where the merging setting main interface is used to display the merging rule table. A header of the merging rule table includes a display name header, a merging rule header, and an exclusive number header. A merging rule item that is already stored is displayed in an entry of the merging rule table. Each merging rule item may include a display name and a merging rule. Optionally, the merging rule item may further include an exclusive number. In this way, by setting an exclusive number, error merging can be prevented.

Optionally, a merging setting on/off button may further be displayed in the merging setting main interface. For the merging setting on/off button, there are an on state and an off state. The user may choose, by means of state switching, to enable or disable a merging function. Correspondingly, the input information in step 103 may further include switching the merging setting on/off button to the on state by the user.

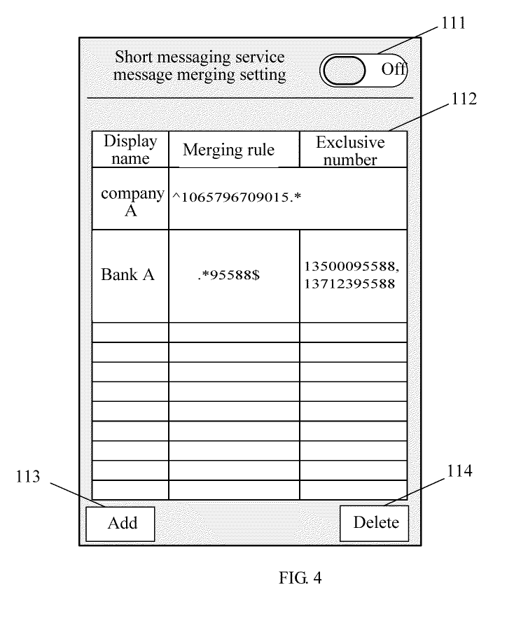

For example, the merging setting main interface may be shown in FIG. 4. A merging setting on/off button 111 and a merging rule table 112 are displayed in the merging setting main interface in FIG. 4. In addition, an add button 113 and a delete button 114 are further displayed.

For example, two merging rule items that are already stored are displayed in the merging rule table 112 in FIG. 4. The first merging rule item includes a display name and a merging rule, where the display name is company A, and the merging rule is ̂1065796709015.*. The second merging rule item includes a display name, a merging rule, and exclusive numbers, where the display name is bank A, the merging rule is.*95588$, and the exclusive numbers are 13500095588 and 13712395588. A display form of the merging rule is a regular expression. The merging rule in the first merging rule item in FIG. 4 indicates that prefixes are the same, and the merging rule in the second merging rule item in FIG. 4 indicates that suffixes are the same.

Optionally, in this embodiment of the present disclosure, the instruction information in step 101 may be an adding instruction of the user in the merging setting main interface. The instruction information in step 101 may be tapping the add button 113 in the merging setting main interface in FIG. 4 by the user. For example, after the merging setting main interface is presented, if the user wants to add a new merging rule item, the user may tap the add button 113 in the merging setting main interface. It may be understood that the merging setting interface in step 102 is triggered by the foregoing adding instruction. The merging setting interface may be shown in FIG. 5. Merging setting information displayed in the merging setting interface includes merging mode options, a display name item, and a merging mode options.

For example, the input information in step 103 may include a merging mode selected by the user in the merging mode options, that is, the exact match mode; a display name input by the user into the display name item, that is, bank B; and a merging condition input by the user in the merging mode options, that is, 95511, 10657924365.

It should be noted that in this embodiment of the present disclosure, in step 103, when the merging mode selected by the user in the merging mode options is the advanced mode, correspondingly, the merging mode options merging condition entered in the merging mode options should be a regular expression.

In this embodiment of the present disclosure, the advanced mode may also be referred to as a custom mode. The user may set a regular expression.

In this embodiment of the present disclosure, a user who has professional knowledge in the computer field may use only the advanced mode to set a merging rule. As shown in Table 1, in different scenarios, several examples of a regular expression in the merging mode options when the advanced mode is selected are provided. In addition, descriptions of corresponding regular expressions are provided.

TABLE 1

| | Example of a merging | |
|---|---|---|
| | condition in an advanced | Description of a matched |
| Scenario | mode | character string |
| Same-prefix mode, | \hat{ }1065796709015.* | Character string whose prefix |
| for example, numbers | | is 1065796709015 and whose |
| 1065796709015498173, | | ending is any character |
| 1065796709015643125, and | | formed by 0 to any quantity |
| 1065796709015765946 of | | of digits |
| company A for sending a | \hat{ }1065796709015[0-9]* | Character string whose prefix |
| public SMS message | | is 1065796709015 and whose |
| | | ending is formed by 0 to any |
| | | quantity of digits ranging |
| | | from 0 to 9 |
| | \hat{ }1065796709015[0-9]{6} | Character string whose prefix |
| | | is 1065796709015 and whose |
| | | ending is formed by six digits |
| | | ranging from 0 to 9 |
| Same-suffix mode, | .*95588$ | Character string whose suffix |
| for example, two numbers of | | is 95588 and whose |
| bank A, that is, 95588 and | | beginning character is any |
| 1065755595588 | | character formed by 0 to any |
| | | quantity of digits |
| | [0-9]*95588$ | Character string whose suffix |
| | | is 95588 and whose |
| | | beginning character is formed |
| | | by 0 to any quantity of digits |
| | | ranging from 0 to 9 |
| Exact match mode; | 95511\|10657924365 | Either of two character |
| for example, two numbers of | | strings 95511 and |
| bank B, that is, 95511 and | | 10657924365 |
| 10657924365 | | |
| Number with a letter | \hat{ }AAB6000[A-Za-z0-9]* | Character string whose prefix |
| | | is AB6000 and whose ending |
| | | is formed by 0 to any |
| | | quantity of digits ranging |
| | | from A to Z, a to z, and 0 to 9 |

For example, numbers of company A for sending a public SMS message belong to the same-prefix mode, and a prefix character string is 1065796709015. In the advanced mode, “̂1065796709015.*” may be entered in the merging mode options, so as to match a character string whose prefix is 1065796709015, whose ending is a character string formed by any character, and whose ending character string may have any quantity of digits; or “̂11065796709015[0-9]*” is entered in the merging mode options, so as to match a character string whose prefix is 1065796709015, whose ending is a character string formed by a character ranging from 0 to 9, and whose ending character string may have any quantity of digits; or “̂1065796709015[0-9]{6}” is entered in the merging mode options, so as to match a character string whose prefix is 1065796709015, whose ending is a character string formed by a character ranging from 0 to 9, and whose ending character string has six digits. That is, a length and/or a form of an ending character string may be further limited in the advanced mode.

For example, numbers of bank A for sending a message belong to the same-suffix mode, and a suffix character string is 95588. In the advanced mode, “0.95588$” may be entered in the merging mode options, so as to match a character string whose suffix is 95588, and whose beginning is a character string that is formed by any character and may have any quantity of digits; or “[0-9]*95588$” is entered in the merging mode options, so as to match a character string whose suffix is 95588, whose beginning is a character string formed by a character ranging from 0 to 9, and whose beginning character string may have any quantity of digits. That is, a form of a beginning character string may be further limited in the advanced mode, and it may be understood that a length of the beginning character string may also be further limited in the advanced mode.

For example, bank B has two completely different numbers, and the two numbers belong to the exact match mode. In the advanced mode, “9551110657924365” may be entered in the merging mode options, so as to match either of two character strings 95511 and 10657924365.

It should be noted that in this embodiment of the present disclosure, a character string is formed by one or more characters, and a character may be a digit, a letter, or another character, which is not limited in the present disclosure.

It may be understood that this embodiment of the present disclosure may be used to match another non-digit character string. As shown in Table 1, in the advanced mode, “AAB6000[A-Za-z0-9]*” may be entered in the merging mode options, so as to match a character string whose prefix is AB6000, whose ending is a character string formed by a character ranging from A to Z, a to z, or 0 to 9, and whose ending character string may have any quantity of digits.

It should be noted that this embodiment of the present disclosure imposes no limitation on a form and a rule of a regular expression.

In addition, the merging setting information displayed in the merging setting interface in step 102 may further include an exclusive number item. Correspondingly, the input information in step 103 may further include an exclusive number entered in the exclusive number item by the user. In this way, error merging can be prevented.

In this embodiment of the present disclosure, a comma may be used to separate multiple exclusive numbers, or a semicolon, a space, or another character may be used between multiple exclusive numbers, which is not limited in the present disclosure.

For example, the merging setting interface in step 102 may be shown in FIG. 5. The merging setting interface in FIG. 5 is an interface for newly adding a merging rule, and the interface for newly adding a merging rule includes merging mode options 21, a display name item 22, a merging condition 23, and an exclusive number item 24. In addition, a cancel button 25, an OK button 26, and a help button 27 are further displayed. Multiple exclusive numbers in the exclusive number item 24 need to be separated by using a comma.

Correspondingly, the confirm operation in step 104 may be tapping the OK button 26 in FIG. 5 by the user.

Alternatively, the user may tap the cancel button 25 in FIG. 5, so as to cancel a current merging setting operation; or the user may tap the help button 27 in FIG. 5, so as to acquire merging setting help, which may be, for example, merging setting instructions.

Optionally, in this embodiment of the present disclosure, the instruction information in step 101 may be an editing instruction of the user in the merging setting main interface. The instruction information in step 101 may be double-tapping or tapping, by the user, a merging rule item that is already stored in the merging setting main interface. For example, after the merging setting main interface shown in FIG. 4 is presented, if the user wants to edit the second merging rule item, the user may double-tap or tap the second merging rule item. It may be understood that the merging setting interface in step 102 is triggered by the foregoing editing instruction. Merging setting information displayed in the merging setting interface includes merging mode options, a display name item, and a merging mode options. Correspondingly, the input information in step 103 further includes a merging mode selected by the user in the merging mode options and a merging condition input by the user into the merging mode options. In addition, a merging mode, a merging name, and a merging condition that are included in the to-be-edited merging rule item are displayed in the merging setting interface. If the to-be-edited merging rule item includes an exclusive number, the exclusive number included in the to-be-edited merging rule item is further displayed in the merging setting interface.

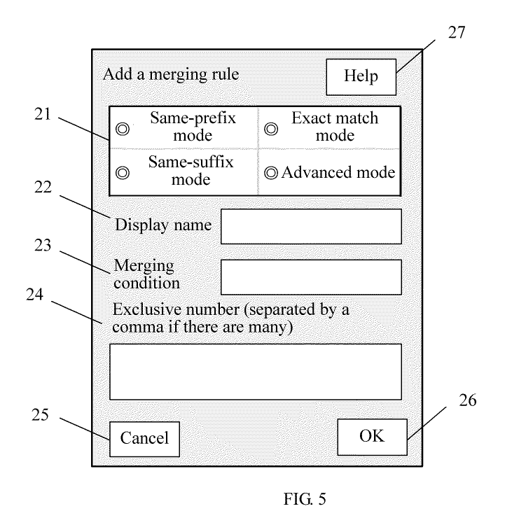

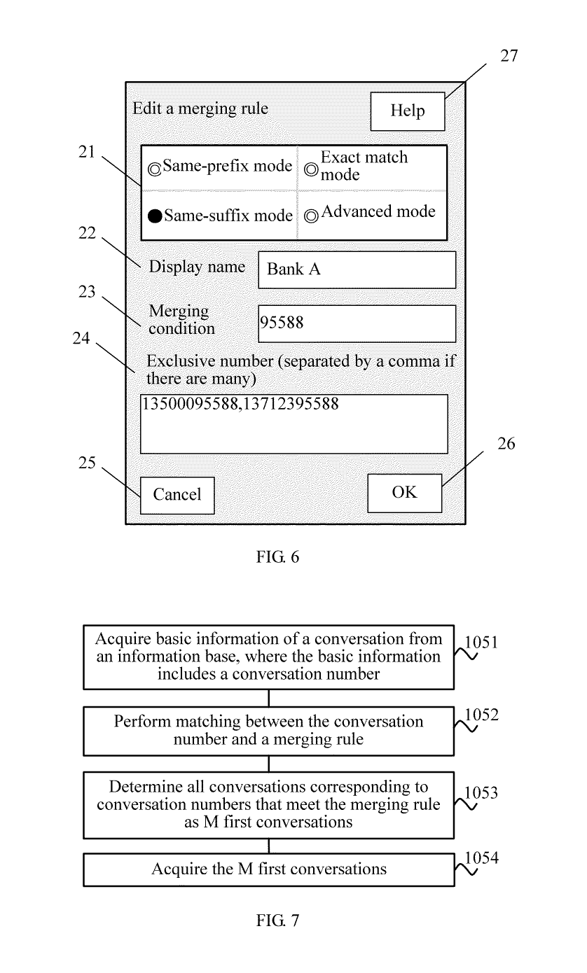

For example, if the instruction information in step 101 is an editing instruction for the second merging rule item in FIG. 4, the merging setting interface in step 102 may be shown in FIG. 6. The merging setting interface in FIG. 6 is a merging rule editing interface that includes merging mode options 21, a display name item 22, a merging condition 23, and an exclusive number item 24. In addition, a cancel button 25, an OK button 26, and a help button 27 are further displayed. In addition, a merging mode, that is, same-suffix mode, in the merging mode options 21, a display name bank A in the display name item 22, a merging condition 95588 in the merging condition 23, and exclusive numbers 13500095588 and 13712395588 in the exclusive number item 24 are further displayed in the merging setting interface in FIG. 6.

Correspondingly, the input information in step 103 may include information about modifying any one or more items in the merging setting information by the user. That is, the input information in step 103 may include information about modifying at least one of the merging mode, the display name, the merging condition, and the exclusive number by the user.

For example, in FIG. 6, the input information may be adding a number 18611995588 to the exclusive number item by the user.

Correspondingly, the confirm operation in step 104 may be tapping the OK button 26 in FIG. 6 by the user.

Further, in step 105, the merging rule may be generated according to the merging mode and merging condition that are determined according to the confirm operation in step 104.

In this embodiment of the present disclosure, the merging rule is indicated in a form of a regular expression.

For example, if the merging mode that is in the merging mode item and determined by using the confirm operation in step 104 is the same-prefix mode, and the merging condition in the merging mode options is “1065796709015”, the merging rule generated in step 105 is “̂1065796709015.*”. If the merging mode that is in the merging mode item and determined by using the confirm operation in step 104 is the same-suffix mode, and the merging condition in the merging mode options is “95588”, the merging rule generated in step 105 is “.*95588$”. If the merging mode that is in the merging mode item and determined by using the confirm operation in step 104 is the exact match mode, and the merging condition in the merging mode options is “95511,10657924365”, the merging rule generated in step 105 is “95511|10657924365”. If the merging mode that is in the merging mode item and determined by using the confirm operation in step 104 is the advanced mode, and the merging condition in the merging mode options is “̂AB6000[A-Za-z0-9]*”, the merging rule generated in step 105 is “̂AB6000[A-Za-z0-9]*”.

Further, the correspondence between the merging rule and the display name that is entered in step 103 may be generated. Optionally, when the input information in step 103 includes an exclusive number, a correspondence between a merging rule, a display name, and an exclusive number may be generated.

Optionally, in this embodiment of the present disclosure, if the user performs a cancel operation in the merging setting interface shown in step 102, the merging setting main interface is returned for presentation.

For example, if the user taps the cancel button 25 shown in FIG. 5 or FIG. 6, the merging setting main interface is returned for presentation as shown in FIG. 4.

It may be understood that in this embodiment of the present disclosure, the correspondence that is between the merging rule and the display name and is generated in step 105 or the correspondence between a merging rule, a display name, and an exclusive name may be presented in a merging rule table in a form of a merging rule item. After step 105, the merging setting main interface may be further presented again.

For example, if the instruction information in step 101 is an adding instruction, the merging setting main interface presented again after step 105 displays the third merging rule item in addition to the two merging rule items displayed in the merging setting main interface in FIG. 4. In addition, a display name in the third merging rule item is the display name input by the user in step 103, and a merging rule in the third merging rule item is the merging rule generated in step 105. If the input information in step 103 further includes an exclusive number input by the user, an exclusive number in the third merging rule item is the exclusive number input by the user in step 103.

It should be noted that in this embodiment of the present disclosure, when a merging mode in selected the merging mode options is the same-prefix mode, the same-suffix mode, or the exact match mode, a merging rule imposes by default no requirement on a length of a to-be-matched character string and a form of characters that form the character string.

For example, if the merging mode selected by the user in the merging mode options in step 103 is the same-prefix mode, and the merging mode options merging condition entered in the merging mode options is 1065796709015, in step 105, the generated merging rule may be “̂1065796709015.*” used to match a character string whose prefix is 1065796709015, whose ending is a character string formed by any character, and whose ending character string may have any quantity of digits. That is, in the same-prefix mode, neither a length nor a form of the ending character string may be limited by default. Optionally, if the user needs to impose a limitation on the length and/or the form of the ending character string, a limitation may be further imposed in the advanced mode. Alternatively, the user may first tap a help button so as to read related instructions, and then, further impose a limitation in the advanced mode.

For example, if the merging mode selected by the user in the merging mode options in step 103 is the same-suffix mode, and the merging mode options merging condition entered in the merging mode options is 95588, in step 105, the generated merging rule may be “.*95588$” used to match a character string whose suffix is 95588, whose beginning is a character string formed by any character, and whose beginning character string may have any quantity of digits. That is, in the same-suffix mode, neither a length nor a form of the beginning character string may be limited by default. Optionally, if the user needs to impose a limitation on the length and/or the form of the beginning character string, a limitation may be further imposed in the advanced mode. Alternatively, the user may first tap a help button so as to read related instructions, and then, further impose a limitation in the advanced mode.

For example, if the instruction information in step 101 is an editing instruction for the second merging rule item, based on the merging setting main interface in FIG. 4, the second merging rule item is updated in the merging setting main interface presented again after step 105.

For example, if the input information in step 103 is adding, by the user, a number 18611995588 to the exclusive number item shown in FIG. 6, in the merging setting main interface presented again after step 105, an updated second merging rule item includes a display name bank A, a merging rule.*95588$, and exclusive numbers 13500095588, 13712395588, and 18611995588.

In this embodiment of the present disclosure, the correspondence in step 105 may be stored in a memory of the mobile terminal. The merging rule table in the merging setting main interface may be presented after the correspondence stored in the memory is read.

If a conversation is an SMS message conversation, a file may be created in a same-layer directory of an SMS message database to store the correspondence. For example, the file in which the correspondence is stored may be a sessionMerge.xml file, and content stored in the sessionMerge.xml file may be shown in Table 2. Correspondingly, the merging rule table presented in the merging setting main interface may include columns corresponding to a display name header, a merging rule header, and an exclusive list header that are in Table 2.

TABLE 2

| | | Display | | |
|---|---|---|---|---|
| No. | Rule type | name | Merging rule | Exclusive list |
| 1 | Same-prefix | Company A | \hat{ }1065796709015.* | |
| | mode | | | |
| 2 | Same-suffix | Bank A | .*95588$ | 13500095588, |
| | mode | | | 13712395588 |
| 3 | Exact match | Bank B | 95511\|10657924365 | NA |
| | mode | | | |
| 4 | Advanced | Company X | [0-9]*955001[0-9]* | |
| | mode | | | |
| 5 | Advanced mode | Company Y | [A-Z]*AB6000[A-Za-z0-9]* | |
| 6 | . . . | . . . | . . . | |

Further, it may be understood that as shown in FIG. 7, step 1111 in FIG. 2 may include:

1051. Acquire basic information of a conversation from an information base, where the basic information includes a conversation number.

1052. Perform matching between the conversation number and the merging rule.

1053. Determine all conversations corresponding to conversation numbers that meet the merging rule as the M first conversations.

1054. Acquire the M first conversations.

Optionally, when the input information in step 103 includes an exclusive number in an exclusive number item, in step 1053, all conversations corresponding to conversation numbers that meet the merging rule and do not belong to the exclusive number are determined as the M first conversations.

In this embodiment of the present disclosure, the basic information of the conversation may further include a conversation ID, where the conversation ID may also be referred to as a conversation thread number allocated by the mobile terminal. The conversation number may be understood as a number of a peer end. For example, when the conversation is an SMS message conversation, the conversation number may be a number of a sender of a received SMS message or a number of a recipient of a sent SMS message.

It should be noted that this embodiment of the present disclosure imposes no limitation on a storage form of a conversation in an information base. An SMS message conversation in an Android system is used as an example. An SMS message system stores both a received SMS message and a sent SMS message into a database. Tables related to an SMS message in the Android system are shown in Table 3, Table 4, and Table 5.

Table 3 is an SMS table, the table is used to store a received SMS message and a sent SMS message, each SMS message is corresponding to one record in the table, and each SMS message has an SMS message ID. For details of included content, reference may be made to Table 3.

TABLE 3

| Field name | Type | Description |
|---|---|---|
| _id | INTEGER | Primary-key ID generated by a system |
| thread_id | INTEGER | Conversation ID corresponding to_id in a threads table |
| address | TEXT | SMS message number |
| person | INTEGER | Sequence number of a corresponding name stored in an |
| | | address book, where this field is null if there is no |
| | | corresponding sequence number |
| date | INTEGER | Information sending/receiving time |
| protocol | INTEGER | Communications protocol that determines whether a |
| | | message is an SMS message or an MMS message, where 0 |
| | | represents an SMS message, and 1 represents an MMS |
| | | message |
| read | INTEGER | Read or not, where 1 represents read, and 0 represents |
| | | unread |
| status | INTEGER | Sending status, where-1 represents received, 0 represents |
| | | complete, 64 represents being in a sending process, and 128 |
| | | represents a failure |
| type | INTEGER | 3 represents drafting, 2 represents sending an SMS |
| | | message, and 1 represents having received an SMS |
| | | message |
| reply_path_present | INTEGER | TP-Reply-Path |
| subject | TEXT | Subject |
| body | TEXT | SMS message content |
| service_center | TEXT | Operator service call |
| locked | INTEGER | Locked or not, where 0 represents unlocked, and 1 |
| | | represents locked |
| sim_id | INTEGER | a SIM card to which an SMS message belongs; applicable |
| | | to a dual SIM dual standby mobile phone |
| error_code | INTEGER | error code of abnormal sending or receiving |
| seen | INTEGER | Identifies whether an SMS message in a status bar is seen, |
| | | where 1 represents seen, and 0 represents not being seen |

Table 4 is a threads table, the table is a conversation ID table, each conversation is corresponding to one record in the threads table, and information, such as a total quantity of SMS messages in a conversation corresponding to a conversation ID and content of the last SMS message in the conversation, is stored in the threads table.

TABLE 4

| Field name | Type | Description |
|---|---|---|
| _id | INTEGER | Primary-key ID generated by a system |
| date | INTEGER | Date |
| message_count | INTEGER | Total quantity of SMS messages |
| recipient_ids | TEXT | Primary key that is of a canonical_addresses table and is |
| | | associated with a conversation number |
| snippet | TEXT | Content of an SMS message that is last sent or received |
| snippet_cs | INTEGER | The charset of the snippet |
| read | INTEGER | Whether all SMS messages have been read, where 1 represents |
| | | read, and 0 represents unread |
| type | INTEGER | Conversation type: an ordinary conversation or a bulk |
| | | conversation |
| error | INTEGER | Whether an error occurs, where 1 represents an error |
| | | occurrence, and 0 represents no error |
| has_attachment | INTEGER | Whether an attachment is included, where 1 represents no |
| | | attachment, and 0 represents that an attachment is included |

Table 5 is a canonical_addresses table, and numbers of all sending parties of received SMS messages and numbers of all receiving parties of sent SMS messages are stored in the table, where the two types of numbers do not include a local phone number.

TABLE 5

| Field name | Type | Description |
|---|---|---|
| _id | INTEGER | Primary-key ID generated by a system |
| address | TEXT | Number of a sender of a received SMS |
| | | message; or number of a recipient of a sent |
| | | SMS message |

A relationship between Table 3, Table 4, and Table 5 may be shown in FIG. 8. It may be learned that thread_id in Table 3 is corresponding to _id in Table 4, and recipient_ids in Table 4 is corresponding to _id in Table 5.

In an Android system, when the mobile terminal receives an SMS message, a process of storing the received SMS message into a database by the mobile terminal is as follows:

A11. Acquire a number N of a sender of the received SMS message.

A12. Query, in addresses of the canonical_addresses table, whether the number N exists; if the number N exists, acquire a value C of an _id field corresponding to the number N, and if the number N does not exist, create a new record and acquire a value C of an _id field corresponding to the number N, where an address of the new record is the number N.

A13. Query, in the threads table, whether a C record is included in recipient_ids; if the C record is included, acquire a value T of a corresponding _id field and update other field information, and if the C record is not included, create a new record, acquire a value T of a corresponding _id field, and update other field information, where a value of recipient_ids of the new record is C.

A14. In the SMS table, use T as a value of thread_id and add a new SMS message record to the SMS table, where a value of person is a sequence number obtained by performing, according to the number N, a query in an address book stored by the user, and if the number N is not stored in the address book, the value of person is null.

A15. Remind the user that an SMS message is received, for example, an SMS message ringtone may be played.

Similarly, when the mobile terminal sends an SMS message, a process of storing the sent SMS message into a database by the mobile terminal is as follows:

A21. Acquire a number N1 of a recipient of the sent SMS message.

A22. Query, in address of the canonical_addresses table, whether the number N1 exists; if the number N1 exists, acquire a value C1 of an _id field corresponding to the number N1, and if the number N1 does not exist, create a new record and acquire a value C1 of an _id field corresponding to the number N1, where address of the new record is the number N1.

A23. Query, in recipient_ids in the threads table, whether a C1 record is included; if the C1 record is included, acquire a value T1 of a corresponding _id field and update other field information, and if the C1 record is not included, create a new record, acquire a value T1 of a corresponding _id field, and update other field information, where a value of recipient_ids of the new record is C1.

A24. In the sms table, use T1 as a value of thread_id and add a new SMS message record to the sms table, where a value of person is a sequence number obtained by performing, according to the number N1, a query in the address book stored by the user, and if the number N1 is not stored in the address book, the value of person is null.

A25. Send a post processing operation, for example, a status bar notification.

After the SMS message is stored, further, a process of displaying an SMS message conversation interface by the mobile terminal is as follows:

A31. The user enters the SMS message conversation interface.

A32. Extract all records in the threads table, establish an association between recipient_ids in the threads table and _id in the canonical_addresses table, use the address in the canonical_addresses table to perform a query in the address book to acquire a corresponding user name, and determine the user name as a conversation name, where if the user name in the address book is blank, the conversation name is a number of the address.

A33. Display a conversation list of all conversations, where each conversation includes a conversation name, content of the last SMS message, and time of the last SMS message, where a total quantity of SMS messages may further be included.

Further, when the user enters a conversation by means of tapping, the mobile terminal finds, by performing a query in the SMS table, content of all SMS messages of the conversation, where the content includes a received SMS message, a sent SMS message, a draft, and the like. In addition, the mobile terminal may display by time all the SMS messages included in the conversation.

In this embodiment of the present disclosure, in step 1051, a conversation number may be obtained by associating the threads table with the canonical address table.

For example, it is assumed that conversation records stored in the threads table include eight records, and corresponding conversation IDs are respectively 123, 124, 125, 234, 247, 365, 985, and 1001. As shown in Table 6, headers of Table 6 are corresponding to the field names in the threads table shown in Table 4, and each row is corresponding to one conversation record.

TABLE 6

| _id | message_count | date | snippet | recipient_ids | read | type | error | has_attachment |
|---|---|---|---|---|---|---|---|---|
| 123 | 1 | 2014/06/01 | Go to | 13 | Yes | Bulk | 0 | 0 |
| | | 08:10:20 | A30 for a | | | | | |
| | | | meeting | | | | | |
| 124 | 1 | 201406/03 | Deliver a | 14 | Yes | Bulk | 0 | 0 |
| | | 18:10:31 | working | | | | | |
| | | | hour | | | | | |
| | | | record in | | | | | |
| | | | time | | | | | |
| 125 | 1 | 2014/06/13 | Attend a | 15 | No | Bulk | 0 | 0 |
| | | 15:10:26 | regular | | | | | |
| | | | project | | | | | |
| | | | meeting | | | | | |
| 234 | 20 | 2014/06/20 | Repayment | 3 | Yes | Ordinary | 0 | 0 |
| | | 15:10:20 | reminder | | | | | |
| | | | of bank A | | | | | |
| 247 | 12 | 2014/06/22 | Card | 24 | No | Ordinary | 0 | 0 |
| | | 10:10:23 | consumption | | | | | |
| | | | details of | | | | | |
| | | | bank A | | | | | |
| 365 | 8 | 2014/06/12 | Repayment | 46 | Yes | Ordinary | 0 | 0 |
| | | 12:10:13 | information | | | | | |
| | | | of | | | | | |
| | | | bank B | | | | | |
| 985 | 10 | 2014/06/25 | Go out | 85 | Yes | Ordinary | 0 | 1 |
| | | 14:10:53 | for tea | | | | | |
| 1001 | 20 | 2014/06/15 | Watch a | 32 | Yes | Ordinary | 0 | 1 |
| | | 11:40:43 | match | | | | | |
| | | | together | | | | | |
| | | | tonight | | | | | |

It is assumed that conversation numbers stored in the canonical_address table are shown in Table 7.

TABLE 7

| _id | Address |
|---|---|
| 13 | 106579670901534567 |
| 14 | 106579670901534568 |
| 15 | 106579670901534569 |
| 23 | 95588 |
| 24 | 10657995588 |
| 32 | 18600001234 |
| 46 | 95511 |
| 85 | 13712395588 |

In this way, the conversation numbers may be acquired by associating recipient_ids in Table 6 with _id in Table 7. Meanwhile, conversation names of conversations may be acquired by performing a query in the stored address book, as shown in Table 8. A conversation ID column in Table 8 is an _id column in Table 6, and a number column in Table 8 is an address column in Table 7. The conversation names in Table 8 are acquired by performing a query in the address book by using the conversation numbers. For conversation numbers that are not stored in the address book, conversation names are the conversation numbers.

TABLE 8

| Conversation ID | Conversation number | Conversation name |
|---|---|---|
| 123 | 106579670901534567 | 106579670901534567 |
| 124 | 106579670901534568 | 106579670901534568 |
| 125 | 106579670901534569 | 106579670901534569 |
| 234 | 95588 | 95588 |
| 247 | 10657995588 | 10657995588 |
| 365 | 95511 | 95511 |
| 985 | 13712395588 | Person A |
| 1001 | 18600001234 | Person B |

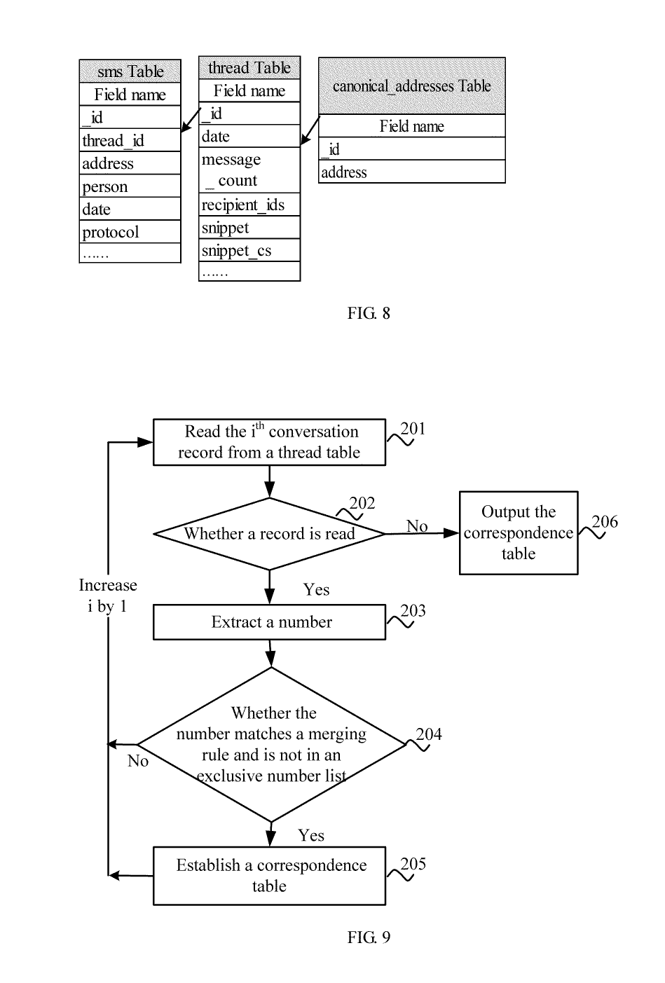

Further, in step 1052, matching may be performed on merging rules one by one by performing a query in the threads table, and a specific implementation manner may be shown in FIG. 9 and includes the following steps:

201. Read the i^{th} conversation record from the threads table, where i is a positive integer, and initially, i=1.

202. Determine whether a record is read in step 201.

If reading is performed on an ending of the threads table, no record can be read, and step 206 is performed, and if a record is read, step 203 is performed.

203. Extract a number of the read i^{th} conversation record.

That is, a conversation number of the i^{th} conversation is extracted.

For example, for _id shown in Table 6, a conversation number may be extracted from the conversation numbers in Table 8 acquired in step 1051.

204. Perform matching between the number extracted in step 203 and a merging rule, and determine whether the number matches a merging rule.

If the user sets multiple merging rules, matching is performed between the extracted number and the multiple merging rules one by one. If the extracted number matches a merging rule, and the extracted number does not belong to an exclusive list of the merging rule, step 205 is performed. If the number extracted in step 203 does not match any merging rule among the multiple merging rules, i is increased by 1, and step 201 continues to be performed.

For example, a number of a conversation whose conversation ID is 123 is 106579670901534567, and matching is performed between the number and a merging rule; it may be determined that the number matches the merging rule “̂1065796709015.*” in Table 2.

For example, a number of a conversation whose conversation ID is 985 is 13712395588, and matches the merging rule “.*95588$” in Table 2; however, the number belongs to an exclusive number. Therefore, the number of the conversation whose conversation ID is 985 does not meet any merging rule in Table 2.

205. Establish a table of a correspondence between a merging rule, a conversation ID, and a conversation number.

The conversation number is the number that is of the record and extracted in step 203. Specifically, if a merging rule that matches the number in step 204 is already in the correspondence table, that is, a table of a correspondence between the merging rule, another number, and another conversation ID is already established, in step 205, there is only a need to add the number of the record in step 203 and a corresponding conversation ID to a record in which the merging rule exists.

For example, when the conversation whose conversation ID is 123 is read, a first table of a correspondence between the conversation ID 123 and the merging rule “̂1065796709015.*” is already established. Afterward, a conversation whose conversation ID is 124 is read, and a number of the conversation still meets the merging rule; in this case, there is only a need to add the number 106579670901534568 of the conversation whose conversation ID is 124 to a number list in the first correspondence table.

Further, after step 205, i is increased by 1, and step 201 continues to be performed.

206. Output the correspondence table.

Specifically, when no record is read in step 202, it may be understood that reading is performed on the ending of the threads table; then the correspondence table that is generated in step 205 is output.

For example, for the threads table shown in Table 6, when i is increased to 9, and no record is read in step 202, step 206 is performed.

For example, in this embodiment of the present disclosure, a table generated by combining the correspondence table that is output in step 206 with the correspondence that is between the merging rule and the display name and is generated in step 105 may be shown in Table 9.

TABLE 9

| Display | | Exclusive | Conversation | |
|---|---|---|---|---|
| name | Merging rule | list | ID | Number list |
| Company A | 1065796709015.* | | 123, 124, 125 | 106579670901534567, |
| | | | | 106579670901534568, |
| | | | | 106579670901534569 |
| Bank A | .*95588 | 13500095588, | 234, 247 | 95588, 10657995588 |
| | | 13712395588 | | |
| Bank B | 95511\|10657924365 | NA | 365 | 95511 |
| . . . | | | | |

In this way, in step 1053, the M first conversations may be determined.

For example, based on Table 9, three groups of M first conversations corresponding to three merging rules may be determined.

Specifically, the first group of M first conversations are M=3 first conversations that meet the merging rule 1065796709015.*, whose conversation IDs are 123, 124, and 125, and whose conversation numbers are 106579670901534567, 106579670901534568, and 106579670901534569.

Specifically, the second group of M first conversations are M=2 first conversations that meet the merging rule.*95588 and that are not included in the exclusive list including 13500095588 and 13712395588, whose conversation IDs are 234 and 247, and whose conversation numbers are 95588 and 10657995588.

Specifically, the third group of M first conversations are M=1 first conversation that meets the merging rule 95511110657924365, whose conversation ID is 365, and whose conversation number is 95511.

Correspondingly, in step 1054, acquiring the M first conversations may be acquiring the three groups of M first conversations.

Further, in step 1112, the M first conversations may be merged into a second conversation.

Specifically, multiple groups of M first conversations acquired in step 1111 are merged into multiple second conversations, and the multiple second conversations are in one-to-one correspondence with the multiple groups of M first conversations.

For example, according to the correspondence table that is in Table 9, a table obtained after the conversations in Table 6 are merged may be shown in Table 10, where one row in Table 10 is corresponding to one second conversation, and headers of Table 10 include field names and display names that are corresponding to the threads table.

It may be understood that in Table 10, the first group of M=3 first conversations are merged into a first piece of second conversation, and a conversation name of the first piece of second conversation is company A; the second group of M=2 first conversations are merged into a second piece of second conversation, and a conversation name of the second piece of second conversation is bank A; the third group of M=1 first conversation is merged into a third piece of second conversation, and a conversation name of the third piece of second conversation is bank B.

TABLE 10

| | Display | | | | | | | |
|---|---|---|---|---|---|---|---|---|
| _id | name | message_count | date | Snippet | read | type | Error | has_attachment |
| 123, | Company A | 3 | 2014/06/13 | Attend a | No | Bulk | 0 | 0 |
| 124, | | | 15:10:26 | regular | | | | |
| 125 | | | | project | | | | |
| | | | | meeting | | | | |
| 234, | Bank A | 32 | 2014/06/22 | Card | No | Ordinary | 0 | 0 |
| 247 | | | 10:10:23 | consumption | | | | |
| | | | | details | | | | |
| | | | | of bank A | | | | |
| 365 | Bank B | 8 | 2014/06/12 | Repayment | Yes | Ordinary | 0 | 0 |
| | | | 12:10:13 | information | | | | |
| | | | | of bank B | | | | |
| 985 | Person A | 10 | 2014/06/25 | Go out for | Yes | Ordinary | 0 | 1 |
| | | | 14:10:53 | tea | | | | |
| 1001 | Person B | 20 | 2014/06/15 | Watch a | Yes | Ordinary | 0 | 1 |
| | | | 11:40:43 | match | | | | |
| | | | | together | | | | |
| | | | | tonight | | | | |

Specifically, when the M first conversations are merged into the second conversation in step 1112, a process of processing content corresponding to field names in a corresponding threads table is as follows:

Conversation ID (_id): Conversation IDs are merged; specifically, conversation IDs that meet a same merging rule in Table 9 are merged into one conversation, and a comma may be used to separate the conversation IDs. Optionally, a semicolon, a space, or another character may also be used to separate the conversation IDs, which is not limited in the present disclosure.

For example, conversation IDs 123, 124, and 125 meet a same merging rule in Table 9; then in Table 10, the conversation IDs 123, 124, and 125 are merged into a same record and separated by using commas.

Display name: A display name of a conversation ID in Table 9 is a corresponding display name in Table 9; a display name of a conversation ID not in Table 9 remains unchanged.

For example, in Table 9, a display name corresponding to the conversation IDs 123, 124, and 125 is company A; then in Table 10, a display name of the conversation IDs 123, 124, and 125 is company A.

Total quantity of SMS messages (message count): SMS messages of all corresponding conversation IDs are summated.

For example, for each of the conversation IDs 123, 124, and 125, a total quantity of SMS messages in Table 9 is 1; then a total quantity of SMS messages in Table 10 is 3.

Time of the last record (date): latest time among time of all corresponding conversations is chosen.

For example, time of the last record of the conversation ID 123 in Table 9 is 2014/06/01 08:10:20, time of the last record of the conversation ID 124 in Table 9 is 2014/06/03 18:10:31, and time of the last record of the conversation ID 125 in Table 9 is 2014/06/13 15:10:26. The latest time 2014/06/13 15:10:26 is chosen; then corresponding time of the last record in Table 10 is 2014/06/13 15:10:26.

Content of the last record (snippet): Content corresponding to time of the last record.

For example, time of the last record of the conversation IDs 123, 124, and 125 is 2014/06/13 15:10:26, and content corresponding to the time is “Attend a regular project meeting”; then content of the last record in Table 10 is “Attend a regular project meeting”.

Whether all have been read (read): Provided “read” of one of all corresponding conversations is no, this field is no.

For example, the record of the conversation ID 125 is no in Table 9; then “read” is no in Table 10.

Conversation type (type): Provided “type” of one of all corresponding conversations is bulk, this field is bulk.

For example, the record of the conversation ID 123 is bulk; then “type” is bulk in Table 10.

Whether an error occurs (error): Provided “error” of one of all corresponding conversations is 1, this field is 1. That is, provided an error occurs in one conversation, an error occurs in a conversation obtained after merging.

For example, for each of the conversation IDs 123, 124, and 125, the record is 0 in Table 9; then “error” is 0 in Table 10.

Whether an attachment is included (has attachment): Provided “has_attachment” of one of all corresponding conversations is 1, this field is 1. That is, provided one conversation has an attachment, a conversation obtained after merging has an attachment.

For example, for each of the conversation IDs 123, 124, and 125, the record is 0 in Table 9; then “has_attachment” is 0 in Table 10.

In this way, when the user views a conversation interface, display is performed according to the second conversation obtained after the merging in step 1112.

For example, as shown in Table 10, five conversations are displayed in a conversation interface. Each conversation includes a display name, content of the last SMS message, and time of the last SMS message, and may further include a total quantity of SMS messages.

In this way, according to the foregoing embodiment, in the present disclosure, multiple first conversations can be merged into a second conversation according to merging setting of a user, and the multiple first conversations are not displayed, which can simplify display of a conversation interface, so that user experience is improved.

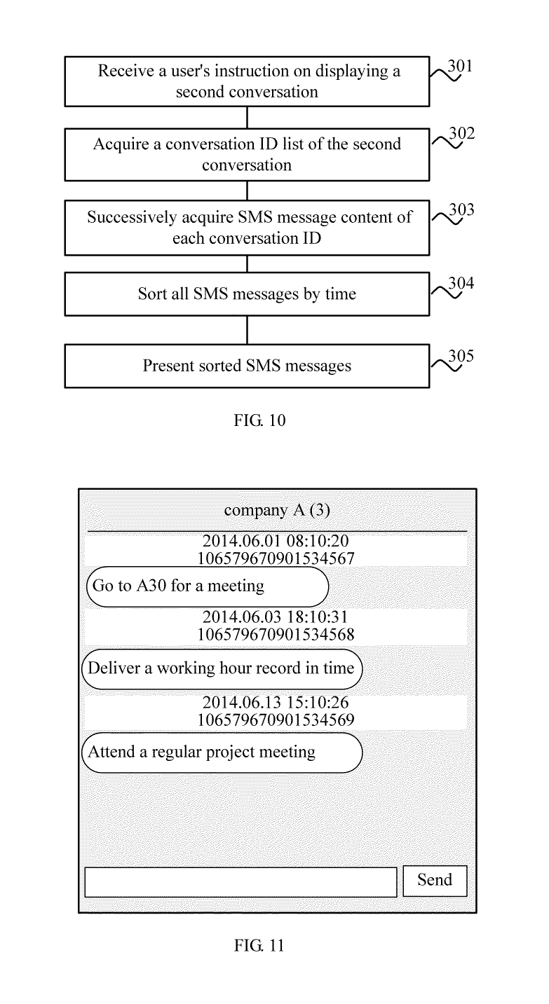

Further, in this embodiment of the present disclosure, in step 1112 shown in FIG. 2, displaying the second conversation may include the following steps, as shown in FIG. 10:

301. Receive the user's instruction on displaying the second conversation.

Specifically, the user's instruction on displaying the second conversation is received in a conversation display interface.

For example, the instruction may be that the user taps a second conversation whose conversation name is company A.

302. Acquire a conversation ID list of the second conversation.

For example, as shown in Table 10, a conversation ID list of the second conversation whose conversation name is company A may be acquired, where conversation IDs in the conversation ID list are 123, 124, and 125.

For another example, a conversation ID list of a second conversation whose conversation name is bank A is acquired, where conversation IDs in the conversation ID list are 234 and 247.

303. Successively acquire SMS message content of each conversation ID.

Specifically, the SMS message content of each conversation ID may be acquired by performing a query in the SMS table.

For example, content of an SMS message whose conversation ID is 123, content of an SMS message whose conversation ID is 124, and content of an SMS message whose conversation ID is 125 may be acquired.

For another example, content of 20 SMS messages whose conversation ID is 234 and content of 12 SMS messages whose conversation ID is 247 may be acquired.

304. Sort all SMS messages according to time of the SMS messages.

In this embodiment of the present disclosure, time of an SMS message may refer to receiving time of a received SMS message, sending time of a sent SMS message, or a time at which a sent SMS message is received, which is not limited in the present disclosure.

It may be understood that in step 304, all SMS messages in a same second conversation are sorted according to time of the SMS messages.

For example, three SMS messages whose conversation IDs are 123, 124, and 125 are sorted.

For another example, 32 SMS messages whose conversation IDs are 234 and 247 are sorted.

305. Present sorted SMS messages.

It may be understood that in step 305, all the SMS messages in the second conversation are presented. Optionally, the SMS messages may be arranged by time in order or in a reverse order.

For example, presentation of the three SMS messages whose conversation IDs are 123, 124, and 125 may be shown in FIG. 11. A conversation name of a conversation in FIG. 11 is company A, where the three SMS messages arranged by time are included. Display of each SMS message includes an SMS message time, an SMS message number, and SMS message content. Optionally, display of each SMS message may include only an SMS message time and SMS message content, which is not limited in the present disclosure. In addition, FIG. 11 further shows a reply box and a send button.

It should be understood that after the method shown in FIG. 2, the second conversation is displayed in the conversation display interface, and the M first conversations are no longer displayed. In this way, a conversation interface can be significantly simplified.

Optionally, after the foregoing embodiment, when a new SMS message is received or the user wants to send an SMS message, the new SMS message may be first stored in a manner of A11 to A15 or A21 to A25. Then, a conversation to which the new SMS message belongs is determined according to a method similar to the foregoing method. To avoid repetition, details are not described herein again.

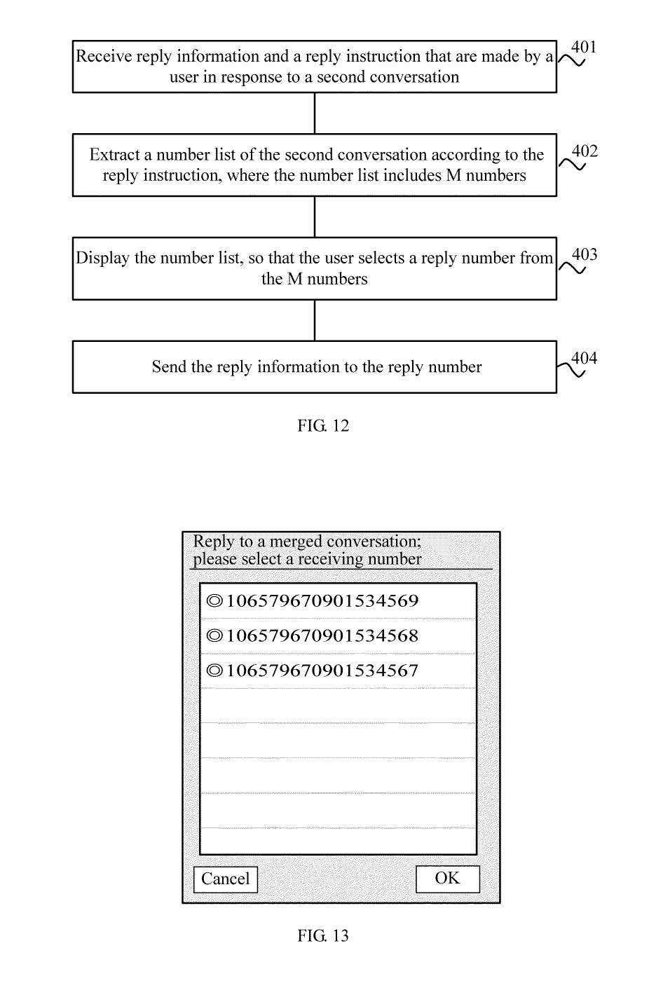

Optionally, after the foregoing embodiment, the method in the present disclosure may further include replying to the second conversation, which is specifically shown in FIG. 12 and includes the following steps:

401. Receive reply information and a reply instruction that are made by a user in response to the second conversation.

For example, for the second conversation shown in FIG. 11, the user may input reply information into the reply box and tap the send button, where tapping the send button is used as a reply instruction.

402. Extract a number list of the second conversation according to the reply instruction, where the number list includes the M numbers.

Specifically, after the reply instruction of the user is received, a number list that includes all numbers of the second conversation is extracted.

It may be understood that the second conversation is obtained by merging the M first conversations; then all the numbers of the second conversation are the M numbers in one-to-one correspondence with the M first conversations.

For example, after the user inputs the reply information into the reply box shown in FIG. 11 and taps the send button, the number list of the second conversation may be extracted from Table 9, where the number list includes three numbers 106579670901534567, 106579670901534568, and 106579670901534569.

403. Display the number list, so that the user selects a reply number from the M numbers.

Optionally, the displayed number list may be arranged in a reverse order according to corresponding time of the last SMS message. That is, a number of an SMS message having the latest time is arranged at the most front. Alternatively, optionally, the displayed number list may be arranged in a reverse order according to a total quantity of corresponding SMS messages. That is, a number with the most SMS messages is arranged at the most front. Alternatively, the displayed number list may be arranged according to another rule, which is not limited in the present disclosure.

For example, FIG. 13 shows a displayed number list the reply information in FIG. 11.

In this way, the user may select one or more numbers in the number list as a reply number. Afterward, the user may tap an OK button to confirm the reply number.

Alternatively, in step 403, the first number in the displayed number list may be selected by default, so that the user modifies or confirms the reply number.

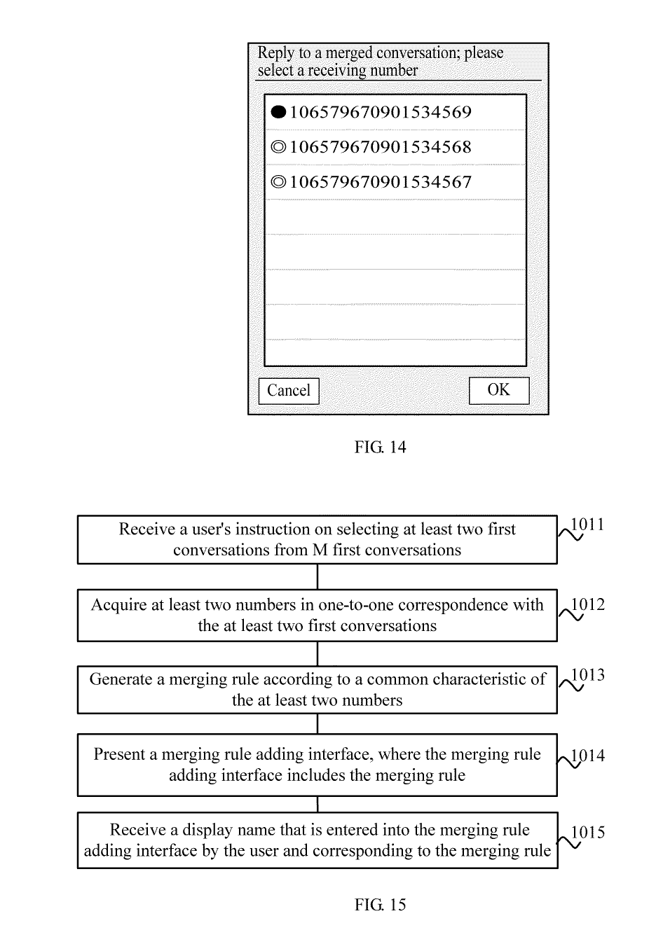

For example, FIG. 14 shows a displayed number list the reply information in FIG. 11, and the first number is selected as a reply number by default.

In this way, the user may reselect a reply number, add a reply number, or make no modification. Afterward, the user may tap an OK button to confirm the reply number.

404. Send the reply information to the reply number.

After step 403, the user may perform a confirm operation on the selected reply number. For example, the confirm operation may be tapping the OK button after the user selects the reply number.

Alternatively, as shown in FIG. 14, for a case in which the first number has been selected as the reply number by default, the confirm operation is tapping the OK button by the user.

It may be understood that step 404 is performed after the confirm operation of the user is acquired.

For example, if the user taps the OK button after selecting the first number in FIG. 14, in step 404, the reply information is sent to a number 106579670901534569.

In this way, the user can perform a reply operation in response to the second conversation obtained after merging.

As described in the foregoing, in this embodiment of the present disclosure, a user sets a merging rule, so that M first conversations that meet a merging rule can be merged into one second conversation, and only the second conversation is displayed, which simplifies display of a conversation interface and facilitates reading and operating of the user, so that user experience can be improved.

For example, after M=3 first conversations whose conversation IDs are 123, 124, and 125 are merged into one second conversation shown in FIG. 11, a delete operation may be performed on the second conversation. In this way, M=3 first conversations can be all deleted by performing one delete operation, which facilitates an operation of the user.

Alternatively, the user may also select and delete one or more SMS messages from the second conversation in the interface shown in FIG. 11.

In addition, in this embodiment of the present disclosure, the user may also delete a stored merging rule item. Specifically, in the merging setting main interface shown in FIG. 4, a merging rule item may be deleted from the merging rule table.

For example, the user may tap to select a merging rule item, and then tap the delete button in the merging setting main interface. A small delete button may occur on the right side of the selected merging rule item, and the user taps the small delete button to perform a delete operation on the selected merging rule item. Alternatively, the user may also tap any area other than the selected merging rule item to cancel the delete operation.

Alternatively, for example, the user may touch and hold, slide left, or slide right a merging rule item, a small delete button may occur on the right side of the selected merging rule item, and the user taps the small delete button to perform a delete operation on the selected merging rule item. Alternatively, the user may also tap any area other than the selected merging rule item to cancel the delete operation.

In addition, in this embodiment of the present disclosure, the user may also cancel merging setting. Specifically, the user may switch the merging setting on/off button to an off state in the merging setting main interface shown in FIG. 4, so as to cancel merging setting.

It may be understood that when the merging setting on/off button is switched to the off state, in the conversation display interface, the M first conversations are displayed, and the second conversation is not displayed.

Optionally, in another embodiment, as shown in FIG. 15, before step 1111, the receiving the preset merging rule set by the user may include:

1011. Receive the user's instruction on selecting at least two first conversations from the M first conversations.

Specifically, the user's instruction information for selecting the at least two first conversations in the conversation display interface may be received.

1012. Acquire at least two numbers in one-to-one correspondence with the at least two first conversations.

1013. Generate the merging rule according to a common characteristic of the at least two numbers.

1014. Present a merging rule adding interface, where the merging rule adding interface includes the merging rule.

1015. Receive the display name that is entered in the merging rule adding interface by the user and corresponding to the merging rule.

Step 1015 may further include receiving the user's modify operation performed on the merging rule in the merging rule adding interface.

It may be understood that before step 1015, a correspondence between the merging rule and the display name may be generated. For details, reference may be made to corresponding descriptions in step 105 in FIG. 3 in the foregoing embodiment. To avoid repetition, details are not described herein again.

In this embodiment of the present disclosure, a menu of the conversation display interface may include an “add a merging rule” button. The user may tap the “add a merging rule” button in the menu of the conversation display interface.

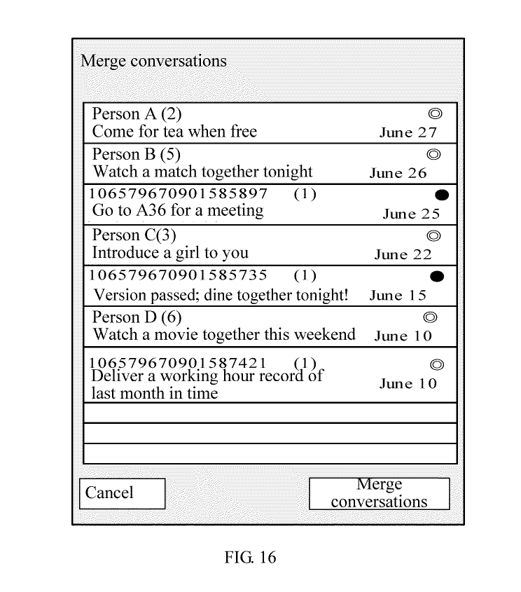

Further, after information about tapping the “add a merging rule” button in the menu of the conversation display interface by the user is received, the conversation display interface may be shown in FIG. 16. In FIG. 16, a check box occurs on the right side of each conversation. In this way, the user may select, by tapping the check box, conversations that the user hopes to merge. Meanwhile, a cancel button and a merge conversations” button are further displayed in the conversation display interface shown in FIG. 16. The user may tap the cancel button to cancel an operation of setting a merging rule.

It may be understood that the instruction in step 1011 refers to information about confirming the selecting at least two first conversations by the user.

For example, for the conversation display interface shown in FIG. 16, after selecting two first conversations whose conversation names are 106579670901585897 and 106579670901585735, the user may tap the “merge conversations” button.

Further, the merging rule in step 1013 may include a merging mode and a merging condition, where the merging mode is one of a same-prefix mode, a same-suffix mode, an exact match mode, and an advanced mode.

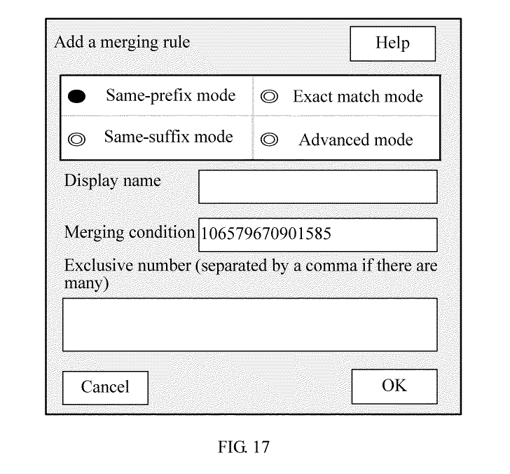

Correspondingly, the merging rule adding interface in step 1014 may also include merging mode options, a merging mode options, and a display name item. For example, as shown in FIG. 17, it may be understood that the merging rule adding interface in step 1014 is consistent with the interface for newly adding a merging rule that is shown in FIG. 5 in the foregoing embodiment. To avoid repetition, details are not described herein again.

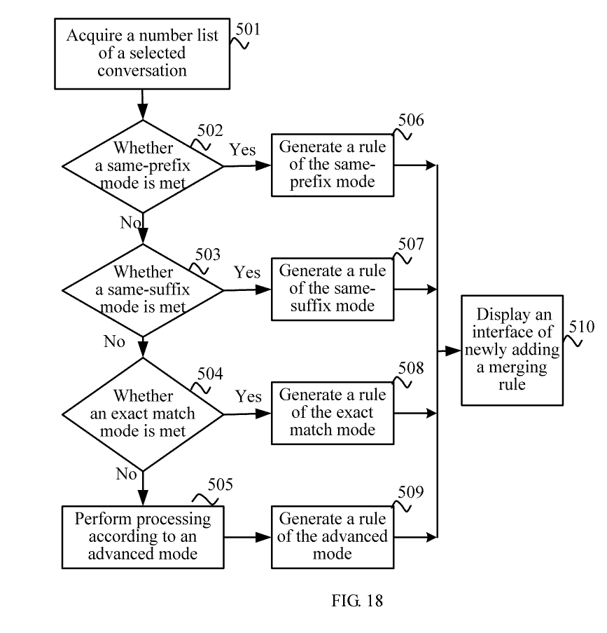

Specifically, processes of steps 1012, 1013, and 1014 may be shown in FIG. 18 and include:

501. Acquire a number list of the at least two first conversations selected in step 1011.

Specifically, step 501 refers to acquiring a list of conversation numbers of the at least two first conversations selected by the user.

For example, for FIG. 16, the acquired list of conversation numbers includes 106579670901585897 and 106579670901585735.

502. Determine whether a list of conversation numbers that is acquired in step 501 meets a same-prefix mode; if the list of conversation numbers that is acquired in step 501 meets the same-prefix mode, perform step 506, and if the list of conversation numbers that is acquired in step 501 does not meet the same-prefix mode, perform step 503.

503. Determine whether the list of conversation numbers that is acquired in step 501 meets a same-suffix mode; if the list of conversation numbers that is acquired in step 501 meets the same-suffix mode, perform step 507, and if the list of conversation numbers that is acquired in step 501 does not meet the same-suffix mode, perform step 504.

504. Determine whether the list of conversation numbers that is acquired in step 501 meets an exact match mode; if the list of conversation numbers that is acquired in step 501 meets the exact match mode, perform step 508, and if the list of conversation numbers that is acquired in step 501 does not meet the exact match mode, perform step 505.

505. Perform processing according to an advanced mode.

506. Generate a rule of the same-prefix mode.

Specifically, the same-prefix mode is selected in the presented merging setting interface, and a same prefix in the number list in step 501 is generated in a corresponding merging mode options.

For example, for the selected two first conversations in FIG. 16, it is determined in step 502 that the same-prefix mode is met, and a same prefix is 106579670901585.

507. Generate a rule of the same-suffix mode.

Specifically, the same-suffix mode is selected in the presented merging setting interface, and a same suffix in the number list in step 501 is generated in a corresponding merging mode options.

508. Generate a rule of the exact match mode.

Specifically, the exact match mode is selected in the presented merging setting interface, and the number list in step 501 is generated in a corresponding merging mode options.

509. Generate a rule of the advanced mode.

Specifically, the advanced mode is selected in the presented merging setting interface. A corresponding merging condition box is left blank to be supplemented by the user.

510. Present the merging rule adding interface.

It should be noted that this embodiment of the present disclosure imposes no limitation on a sequence of steps 502, 503, and 504.

Optionally, the merging rule adding interface in step 1014 may further include an exclusive number item. Correspondingly, in step 1015, an exclusive number entered in the exclusive number item by the user may further be received.

Optionally, in step 1015, a merging condition input or modified by the user may further be received. It may be understood that when a merging mode selected in the merging mode options in the merging rule adding interface in step 1014 is the same-prefix mode, the same-suffix mode, or the exact match mode, a merging condition modified by the user may further be received in step 1015. When the merging mode selected in the merging mode options in the merging rule adding interface in step 1014 is the advanced mode, a merging condition input by the user may further be received in step 1015.

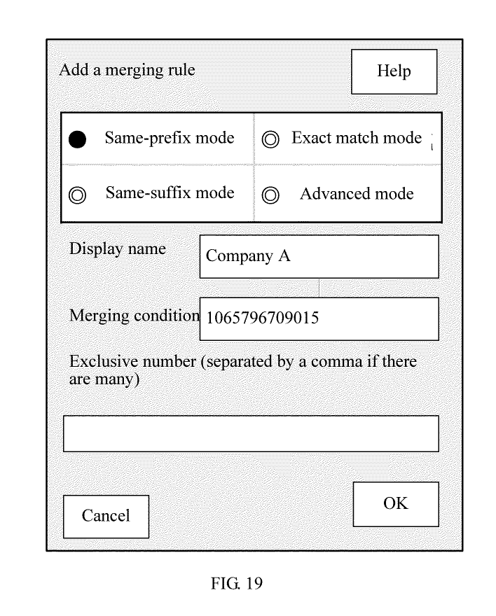

For example, the user may perform an input operation based on FIG. 17. Input information includes a display name company A entered in the display name item, and the input information further includes a merging condition 1065796709015 obtained after modifying in the merging mode options, as shown in FIG. 19.

Further, the user may perform a confirm operation. For example, an OK button in FIG. 19 may be tapped to perform the confirm operation.

In this way, afterward, steps 1111 and 1112 are performed; therefore, M first conversations that meet the merging rule shown in FIG. 19 can be merged into a second conversation.

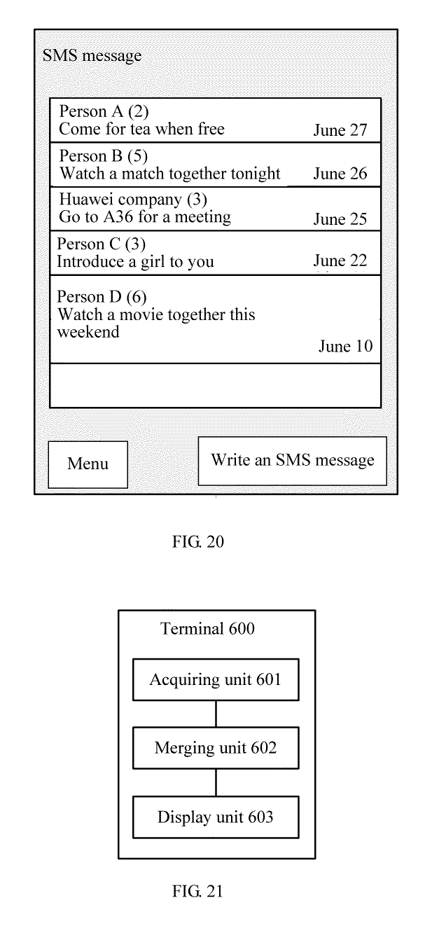

For example, a conversation presentation interface after conversations shown in FIG. 16 are merged may be shown in FIG. 20. It may be seen that the M=3 first conversations that meet the merging rule in FIG. 19 are no longer displayed; the second conversation is displayed in FIG. 20, and a conversation name of the second conversation is company A.

In some cases, only after receiving SMS messages, a user can know which SMS messages are received from a same company. That is, only after receiving SMS messages, the user hopes to merge some conversations. In this embodiment of the present disclosure, the user can perform merging setting by only selecting, in an SMS message interface, at least two first conversations that the user hopes to merge. In this way, an operation of the user can be facilitated, so that user experience can be improved.

FIG. 21 is a block diagram of a mobile terminal according to an embodiment of the present disclosure. A mobile terminal 600 shown in FIG. 21 includes an acquiring unit 601, a merging unit 602, and a display unit 603.

The acquiring unit 601 is configured to acquire M first conversations, where M numbers in one-to-one correspondence with the M first conversations meet a preset merging rule, each first conversation in the M first conversations includes at least one message, the message is a received message or a sent message, a number corresponding to each first conversation in the M first conversations is a number of the message at least included in each first conversation in the M first conversations, the number of the message is a number of a sender of the received message or a number of a recipient of the sent message, and M is a positive integer greater than or equal to 2.

The merging unit 602 is configured to merge the M first conversations acquired by the acquiring unit 601 into a second conversation.

The display unit 603 is configured to display the second conversation obtained after the merging by the merging unit 602, where display content of the second conversation includes messages included in the M first conversations.

In this embodiment of the present disclosure, multiple first conversations whose numbers meet a merging rule are merged into one second conversation, and the second conversation is displayed while display of the multiple first conversations is canceled, which simplifies display of a conversation interface and facilitates reading and operating of a user, so that user experience can be improved.

Optionally, in an embodiment, the preset merging rule includes a merging mode and a merging condition corresponding to the merging mode.

The merging mode is a same-prefix mode, the merging condition corresponding to the merging mode is a first number, and that M numbers meet a preset merging rule includes that prefix numbers of the M numbers are all the first number; or the merging mode is a same-suffix mode, the merging condition corresponding to the merging mode is a second number, and that M numbers meet a preset merging rule includes that suffix numbers of the M numbers are all the second number.

Optionally, in another embodiment, the preset merging rule is a preset number set.

That M numbers meet a preset merging rule includes that the M numbers all belong to the preset number set.

Optionally, in another embodiment, the mobile terminal 600 may further include a receiving unit, an extracting unit, and a sending unit.

The receiving unit is configured to receive reply information and a reply instruction that are made by a user in response to the second conversation displayed by the display unit. The extracting unit is configured to extract, according to the reply instruction received by the receiving unit, a number list of the second conversation displayed by the display unit, where the number list includes the M numbers. The display unit 603 is further configured to display the number list, so that the user selects a reply number from the M numbers. The sending unit is configured to send the reply information received by the receiving unit to the reply number.

Optionally, in another embodiment, the preset merging rule is set by the user, and the mobile terminal further includes the receiving unit configured to receive the preset merging rule set by the user.

Optionally, in another embodiment, the receiving unit is further configured to receive the user's instruction on selecting at least two first conversations from the M first conversations; acquire at least two numbers in one-to-one correspondence with the at least two first conversations; and generate the preset merging rule according to a common characteristic of the at least two numbers, where the common characteristic includes some same digits in the at least two numbers.

Optionally, in another embodiment, the receiving unit is further configured to receive the user's modify operation performed on the preset merging rule, and determine a new merging rule as the preset merging rule according to the modify operation.

Optionally, in another embodiment, the receiving unit is further configured to receive an exclusive number that is entered by the user and corresponding to the preset merging rule; that M numbers meet a preset merging rule includes that the M numbers meet the preset merging rule, and the M numbers do not belong to the exclusive number corresponding to the preset merging rule.

Optionally, in another embodiment, the display content of the second conversation further includes a conversation name, and the conversation name is a default name or a user-defined name.

Optionally, in another embodiment, the first conversation is an SMS message conversation, the second conversation is an SMS message conversation, and the messages are SMS messages.

Optionally, in another embodiment, the mobile terminal 600 is a mobile telephone.

The mobile terminal 600 can implement processes implemented by a mobile terminal in the embodiment of FIG. 2 to FIG. 20. To avoid repetition, details are not described herein again.

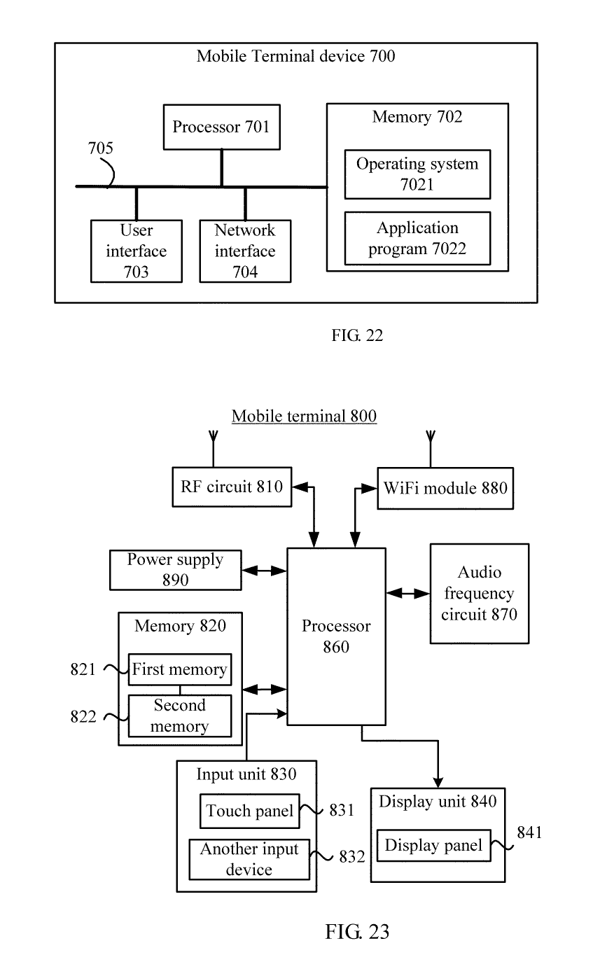

FIG. 22 is a block diagram of a mobile terminal according to another embodiment of the present disclosure. A mobile terminal 700 shown in FIG. 22 includes at least one processor 701, a memory 702, at least one network interface 704, and another user interface 703. Components in the mobile terminal 700 are coupled together by using a bus system 705. It may be understood that the bus system 705 is configured to implement connection and communication between these components. In addition to a data bus, the bus system 705 includes a power bus, a control bus, a status signal bus, and the like. However, for clarity of description, various buses are marked as the bus system 705 in FIG. 22.

The user interface 703 may include a monitor, a keyboard or a clicking device (such as a mouse or a trackball (trackball)), a touchpad, a touchscreen, and the like.

It may be understood that the memory 702 in this embodiment of the present disclosure may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM) that is used as an external cache. By using a description that is exemplary but not restrictive, many forms of RAMs are available, such as a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchlink dynamic random-access memory (SLDRAM), and a direct Rambus random-access memory (DR RAM). The memory 702 in a system and a method that are described in the specification is intended to include but is not limited to these memories and any other memory of an appropriate type.

In some implementation manners, the memory 702 stores the following elements: an executable module or a data structure, a subset thereof, or an extended set thereof an operating system 7021 and an application program 7022.

The operating system 7021 includes various system programs such as a framework layer, a kernel library layer, and a driver layer that are shown in FIG. 1, and is used to implement various basic services and process a hardware-based task. The application program 7022 includes various application programs such as a launcher, a media player, and a browser that are shown in FIG. 1, and is used to implement various application services. A program that implements a method in an embodiment of the present disclosure may be included in the application program 7022.

In this embodiment of the present disclosure, by invoking a program or an instruction that is stored in the memory 702 and may be specifically a program or an instruction stored in the application program 7022, the processor 701 is configured to acquire M first conversations, where M numbers in one-to-one correspondence with the M first conversations meet a preset merging rule, each first conversation in the M first conversations includes at least one message, the message is a received message or a sent message, a number corresponding to each first conversation in the M first conversations is a number of the message at least included in each first conversation in the M first conversations, the number of the message is a number of a sender of the received message or a number of a recipient of the sent message, and M is a positive integer greater than or equal to 2; and merge the M first conversations into a second conversation, and display the second conversation, where display content of the second conversation includes messages included in the M first conversations.

In this embodiment of the present disclosure, multiple first conversations whose numbers meet a merging rule are merged into one second conversation, and the second conversation is displayed while the multiple first conversations are not displayed, which simplifies display of a conversation interface and facilitates reading and operating of a user, so that user experience can be improved.

The method disclosed in the foregoing embodiment of the present disclosure may be applied to the processor 701 or implemented by the processor 701. The processor 701 may be an integrated circuit chip and has a signal processing capability. In an implementation process, the steps in the foregoing method may be completed by means of an integrated logic circuit of hardware in the processor 701 or an instruction in a form of software. The foregoing processor 701 may be a general-purpose processor, a digital signal processor (DSP), an application specific integrated circuit (ASIC), a field programmable gate array (FPGA) or another programmable logic component, a discrete gate or a transistor logic component, or a discrete hardware component, which may implement or perform the methods, the steps, and the logical block diagrams disclosed in the embodiments of the present disclosure. The general-purpose processor may be a microprocessor, or the processor may be any conventional processor or the like. The steps of the method disclosed in the embodiments of the present disclosure may be directly executed by a hardware decoding processor, or executed by a combination of hardware and software modules in a decoding processor. The software module may be located in a mature storage medium in the art such as a random access memory, a flash memory, a read-only memory, a programmable read-only memory, an electrically erasable programmable memory, or a register. The storage medium is located in the memory 702. The processor 701 reads information from the memory 702, and completes the steps of the foregoing method in combination with hardware of the processor 701.

It may be understood that these embodiments described in the specification may be implemented by hardware, software, firmware, middleware, microcode, or a combination thereof. For implementation by hardware, a processing unit may be implemented in one or more ASICs, a DSP, a DSP device (DSPD), a programmable logic device (PLD), an FPGA, a general-purpose processor, a controller, a microcontroller, a microprocessor, another electronic unit that is configured to perform the functions in this application, or a combination thereof.

When an embodiment is implemented in hardware, firmware, middleware, microcode, program code, or a code segment, the hardware, the firmware, the middleware, the microcode, the program code, and the code segment may be stored in a machine readable medium, for example, a storage component. The code segment may indicate any combination of a process, a function, a subprogram, a program, a routine, a subroutine, a module, a software group, a class, an instruction, a data structure, and a program statement. The code segment may be coupled to another code segment or a hardware circuit by transferring and/or receiving information, data, an independent variable, a parameter, or memory content. Any appropriate manner such as memory sharing, message transfer, token transfer, or network transmission may be used to transfer, forward, or send information, an independent variable, a parameter, data, or the like.

For implementation by software, a module (such as a process or a function) that performs the functions in the specification may be used to implement the technology described in the specification. Software code may be stored in a memory unit and is executed by a processor. The memory unit may be implemented in the processor or outside the processor. In the latter case, the memory unit may be coupled to the processor in a communication mode by using various means well known in the art.

Optionally, in an embodiment, the preset merging rule includes a merging mode and a merging condition corresponding to the merging mode.

The merging mode is a same-prefix mode, the merging condition corresponding to the merging mode is a first number, and that M numbers meet a preset merging rule includes that prefix numbers of the M numbers are all the first number; or the merging mode is a same-suffix mode, the merging condition corresponding to the merging mode is a second number, and that M numbers meet a preset merging rule includes that suffix numbers of the M numbers are all the second number.

Optionally, in another embodiment, the preset merging rule is a preset number set.

That M numbers meet a preset merging rule includes that the M numbers all belong to the preset number set.

Optionally, in another embodiment, reply information and a replay instruction that are made by a user in response to the second conversation may be received by using the user interface 703. The processor 701 is configured to extract a number list of the second conversation according to the reply instruction, where the number list includes the M numbers; further configured to display the number list, so that the user selects a reply number from the M numbers; and further configured to send the reply information to the reply number.

Optionally, in another embodiment, the preset merging rule is set by the user, and the mobile terminal 700 is further configured to receive, by using the user interface 703, the preset merging rule set by the user.

Optionally, in another embodiment, the processor 701 is further configured to receive the user's instruction on selecting at least two first conversations from the M first conversations; acquire at least two numbers in one-to-one correspondence with the at least two first conversations; and generate the preset merging rule according to a common characteristic of the at least two numbers, where the common characteristic includes some same digits in the at least two numbers.

Optionally, in another embodiment, the processor 701 is further configured to receive the user's modify operation performed on the preset merging rule, and determine a new merging rule as the preset merging rule according to the modify operation.

Optionally, in another embodiment, the processor 701 is further configured to receive an exclusive number that is entered by the user and corresponding to the preset merging rule; that M numbers meet a preset merging rule includes that the M numbers meet the preset merging rule, and the M numbers do not belong to the exclusive number corresponding to the preset merging rule.

Optionally, in another embodiment, the display content of the second conversation further includes a conversation name, and the conversation name is a default name or a user-defined name.

Optionally, in another embodiment, the first conversation is an SMS message conversation, the second conversation is an SMS message conversation, and the messages are SMS messages.

Optionally, in another embodiment, the mobile terminal 700 is a mobile telephone.

The mobile terminal 700 can implement processes implemented by a mobile terminal in the foregoing embodiment. To avoid repetition, details are not described herein again.

FIG. 23 is a schematic structural diagram of a mobile terminal according to another embodiment of the present disclosure. Specifically, a mobile terminal 800 in FIG. 23 may be a mobile phone, a tablet computer, a PDA, a point of sales (POS), a vehicle-mounted computer, or the like.

The mobile terminal 800 in FIG. 23 includes a radio frequency (RF) circuit 810, a memory 820, an input unit 830, a display unit 840, a processor 860, an audio frequency circuit 870, a Wireless Fidelity (WiFi) module 880, and a power supply 890.

The input unit 830 may be configured to receive digital or character information input by a user, and generate signal input related to user setting and function control of the mobile terminal 800. Specifically, in this embodiment of the present disclosure, the input unit 830 may include a touch panel 831. The touch panel 831, also referred to as a touchscreen, may collect a touch operation of the user on or near the touch panel 831 (for example, an operation of the user on the touch panel 831 by using any appropriate object or accessory such as a finger or a stylus), and drive a corresponding connection apparatus according to a preset program. Optionally, the touch panel 831 may include two parts, a touch detection apparatus and a touch controller. The touch detection apparatus detects a touch orientation of the user, detects a signal brought by a touch operation, and transfers the signal to the touch controller. The touch controller receives touch information from the touch detection apparatus, converts the touch information into coordinates of a touch point, sends the coordinates of the touch point to the processor 860, and can receive and execute a command sent by the processor 860. In addition, the touch panel 831 may be implemented by using multiple types such as a resistive type, a capacitive type, infrared, and a surface acoustic wave. In addition to the touch panel 831, the input unit 830 may include another input device 832, where the another input device 832 may include but is not limited to one or more of a physical keyboard, a functional button (such as a volume control button or an on/off button), a trackball, a mouse, a joystick, and the like.

The display unit 840 may be configured to display information input by the user or information provided for the user and various menu interfaces of the mobile terminal 800. The display unit 840 may include a display panel 841. Optionally, a form such as an LCD or an organic light-emitting diode (OLED) may be used to configure the display panel 841.

It should be noted that the touch panel 831 may cover the display panel 841 to form a touch display screen. After detecting a touch operation on or near the touch display screen, the touch display screen transfers the touch operation to the processor 860, so as to determine a type of a touch event, and afterward, the processor 860 provides corresponding visual output on the touch display screen according to the type of the touch event.

The touch display screen includes an application program interface display area and an area for displaying a commonly used control. An arrangement manner of the application program interface display area and the area for displaying a commonly used control is not limited, and may be an arrangement manner in which the two display areas can be distinguished, such as an up-down arrangement or a left-right arrangement. The application program interface display area may be used to display an interface of an application program, where each interface may include at least one interface element such as an icon and/or a widget desktop control of an application program. The application program interface display area may also be a blank interface that does not include any content. The area for displaying a commonly used control is used to display a control with a relatively high use rate, for example, an application program icon, such as a setting button, an interface serial number, a scroll bar, or a phone book icon.

The processor 860 is a control center of the mobile terminal 800, connects all parts of the entire mobile phone by using various interfaces and lines, and executes various functions of the mobile terminal 800 and processes data by operating or executing a software program and/or a module stored in a first memory 821 and invoking data stored in a second memory 822, so as to perform overall monitoring on the mobile terminal 800. Optionally, the processor 860 may include one or more processing units.

In this embodiment of the present disclosure, by invoking the software program and/or the module stored in the first memory 821 and/or the data in the second memory 822, the processor 860 is configured to acquire M first conversations, where M numbers in one-to-one correspondence with the M first conversations meet a preset merging rule, each first conversation in the M first conversations includes at least one message, the message is a received message or a sent message, a number corresponding to each first conversation in the M first conversations is a number of the message at least included in each first conversation in the M first conversations, the number of the message is a number of a sender of the received message or a number of a recipient of the sent message, and M is a positive integer greater than or equal to 2; and merge the M first conversations into a second conversation, and display the second conversation, where display content of the second conversation includes messages included in the M first conversations.

In this embodiment of the present disclosure, multiple first conversations whose numbers meet a merging rule are merged into one second conversation, and only the second conversation is displayed, which implements simplification of a conversation interface and facilitates reading and operating of a user, so that user experience is improved.

It may be understood that in this embodiment of the present disclosure, the preset merging rule may be stored in the second memory 822.

Optionally, in an embodiment, the preset merging rule includes a merging mode and a merging condition corresponding to the merging mode.

The merging mode is a same-prefix mode, the merging condition corresponding to the merging mode is a first number, and that M numbers meet a preset merging rule includes that prefix numbers of the M numbers are all the first number; or the merging mode is a same-suffix mode, the merging condition corresponding to the merging mode is a second number, and that M numbers meet a preset merging rule includes that suffix numbers of the M numbers are all the second number.

Optionally, in another embodiment, the preset merging rule is a preset number set.

That M numbers meet a preset merging rule includes that the M numbers all belong to the preset number set.

Optionally, in another embodiment, reply information and a replay instruction that are made by a user in response to the second conversation may be received by using the input unit 830. For example, information and an operation of touching a specific location may be entered in the touch display screen. The processor 860 is configured to extract a number list of the second conversation according to the reply instruction, where the number list includes the M numbers; further configured to display the number list on the display unit 840, so that the user selects a reply number from the M numbers; and further configured to send the reply information to the reply number.

Optionally, in another embodiment, the preset merging rule is set by the user, and the mobile terminal 800 is further configured to receive, by using the input unit 830, the preset merging rule set by the user.

It should be noted that the mobile terminal 800 can implement processes implemented by a mobile terminal in the foregoing embodiment. To avoid repetition, details are not described herein again.

It may be learned that according to the mobile terminal provided in this embodiment of the present disclosure, multiple first conversations whose numbers meet a merging rule are merged into one second conversation, and the second conversation is displayed while the multiple first conversations are not displayed, which simplifies display of a conversation interface and facilitates reading and operating of a user, so that user experience can be improved.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present disclosure. The foregoing storage medium includes any medium that can store program code, such as a Universal Serial Bus (USB) flash drive, a removable hard disk, a ROM, a RAM, a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A conversation merging method, wherein the method is applied to a mobile terminal, and wherein the method comprises:
acquiring M first conversations, wherein M correspondence numbers in one-to-one correspondence with the M first conversations meet a preset merging rule, wherein each first conversation in the M first conversations comprises at least one message, wherein each message is a received message, wherein each correspondence number corresponds to a message number of the at least one message of a corresponding first conversation, wherein each message number is a sender number of a sender of the received message, and wherein M is a positive integer greater than or equal to 2;
merging the M first conversations into a second conversation; and
displaying the second conversation, wherein display content of the second conversation comprises the messages in the M first conversations.

2. The method according to claim 1, wherein the preset merging rule comprises:
a merging mode; and
a merging condition corresponding to the merging mode,
wherein the merging mode is a same-prefix mode or a same-suffix mode,
wherein the merging condition comprises a first number,
wherein the M correspondence numbers that meet the preset merging rule comprise a same prefix number corresponding to the first number when the merging mode is the same-prefix mode, and
wherein the M correspondence numbers that meet the preset merging rule comprises a same suffix number corresponding to the first number when the merging mode is the same-suffix mode.

3. The method according to claim 1, wherein the preset merging rule is a preset number set, and wherein the M correspondence numbers that meet the preset merging rule belong to the preset number set.

4. The method according to claim 1, further comprising:
receiving a user input comprising reply information and a reply instruction in response to the second conversation;
extracting a number list of the second conversation according to the reply instruction, wherein the number list comprises the M correspondence numbers;
displaying the number list;
receiving a reply number of the number list; and
sending the reply information to the reply number.

5. The method according to claim 1, further comprising receiving a first user input comprising the preset merging rule before acquiring the M first conversations.

6. The method according to claim 5, wherein receiving the preset merging rule comprises:
receiving a second user input comprising an instruction on selecting at least two first conversations from the M first conversations;
acquiring at least two correspondence numbers in one-to-one correspondence with the at least two first conversations; and
generating the preset merging rule according to a common characteristic of the at least two correspondence numbers, wherein the common characteristic comprises one or more same digits in the at least two correspondence numbers.

7. The method according to claim 6, further comprising:
receiving a third user input comprising a modify operation performed on the preset merging rule; and
determining a new merging rule as the preset merging rule according to the modify operation.

8. The method according to claim 5, further comprising receiving a second user input comprising an exclusive number corresponding to the preset merging rule, wherein the M correspondence numbers that meet the preset merging rule do not belong to the exclusive number.

9. The method according to claim 1, wherein the display content of the second conversation further comprises a conversation name, and wherein the conversation name is a default name.

10. The method according to claim 1, wherein the first conversations are first short message service (SMS) message conversations, wherein the second conversation is a second SMS message conversation, and wherein the messages are third SMS messages.

11. A mobile terminal, comprising:
a processor configured to:
acquire M first conversations, wherein M correspondence numbers in one-to-one correspondence with the M first conversations meet a preset merging rule, wherein each first conversation in the M first conversations comprises at least one message, wherein each message is a received message, wherein each correspondence number corresponds to a message number of the at least one message of a corresponding first conversation, wherein the message number is a sender number of a sender of the received message, and wherein M is a positive integer greater than or equal to 2;
merge the M first conversations acquired by the acquiring unit into a second conversation; and
a display coupled to the processor and configured to display the second conversation merged by the merging unit, wherein display content of the second conversation comprises the messages in the M first conversations.

12. The mobile terminal according to claim 11, wherein the preset merging rule comprises:
a merging mode; and
a merging condition corresponding to the merging mode,
wherein the merging mode is a same-prefix mode or a same-suffix mode,
wherein the merging condition comprises a first number,
wherein M correspondence numbers that meet the preset merging rule comprise a same prefix number corresponding to the first number when the merging mode is the same-prefix mode, and wherein the M correspondence numbers that meet the preset merging rule comprise a same suffix number corresponding to the first number when the merging mode is the same-suffix mode.

13. The mobile terminal according to claim 11, wherein the preset merging rule is a preset number set, and wherein the M correspondence numbers that meet the preset merging rule belong to the preset number set.

14. The mobile terminal according to claim 11, further comprising:
a transmitter coupled to the processor; and
a receiver coupled to the processor and configured to receive a user input comprising reply information and a reply instruction in response to the second conversation displayed by the display;
wherein the processor is further configured to extract, according to the reply instruction, a number list of the second conversation displayed by the display, wherein the number list comprises the M correspondence numbers,
wherein the display is further configured to display the number list to enable the user to select a reply number from the M correspondence numbers; and
wherein the transmitter is configured to send the reply information received by the receiver to the reply number.

15. The mobile terminal according to claim 11, further comprising a receiver coupled to the processor and configured to receive a first user input comprising the preset merging rule.

16. The mobile terminal according to claim 15, wherein the receiver is further configured to:
receive a second user input comprising an instruction on selecting at least two first conversations from the M first conversations;
acquire at least two correspondence numbers in one-to-one correspondence with the at least two first conversations; and
generate the preset merging rule according to a common characteristic of the at least two correspondence numbers, wherein the common characteristic comprises one or more same digits in the at least two correspondence numbers.

17. The mobile terminal according to claim 16, wherein the receiver is further configured to:
receive a third user input comprising a modify operation performed on the preset merging rule; and
determine a new merging rule as the preset merging rule according to the modify operation.

18. The mobile terminal according to claim 15, wherein the receiver is further configured to receive a second user input comprising an exclusive number and corresponding to the preset merging rule, and wherein the M correspondence numbers that meet the preset merging rule do not belong to the exclusive number corresponding to the preset merging rule.

19. The mobile terminal according to claim 11, wherein the display content of the second conversation further comprises a conversation name corresponding to a default name or a user-defined name.

20. The mobile terminal according to claim 11, wherein the first conversations are first short message service (SMS) message conversation, wherein the second conversation is a second SMS message conversation, and wherein the messages are third SMS messages.

21. A conversation merging method, wherein the method is applied to a mobile terminal, and wherein the method comprises:
acquiring M first conversations, wherein M correspondence numbers in one-to-one correspondence with the M first conversations meet a preset merging rule, wherein each first conversation in the M first conversations comprises at least one message, wherein each message is a sent message, wherein each correspondence number corresponds to a message number of the at least one message of a corresponding first conversation, wherein each message number is a recipient number of a recipient of the sent message, and wherein M is a positive integer greater than or equal to 2;
merging the M first conversations into a second conversation; and
displaying the second conversation, wherein display content of the second conversation comprises the messages in the M first conversations.

22. A mobile terminal, comprising:
a processor configured to:
acquire M first conversations, wherein M correspondence numbers in one-to-one correspondence with the M first conversations meet a preset merging rule, wherein each first conversation in the M first conversations comprises at least one message, wherein each message is a sent message, wherein each correspondence number corresponds to a message number of the at least one message of a corresponding first conversation, wherein the message number is a recipient number of a recipient of the sent message, and wherein M is a positive integer greater than or equal to 2;
merge the M first conversations acquired by the acquiring unit into a second conversation; and
a display coupled to the processor and configured to display the second conversation merged by the merging unit, wherein display content of the second conversation comprises the messages in the M first conversations.
